(19) United States
(12) Patent Application Publication
(10) Pub. No.: US 2009/0123507 A1
(43) Pub. Date: May 14, 2009

(54) Metal Oxide Nanoparticles Coated With Specific N-Acylaminomethylene Phosphonates

(76) Inventors: Reinhold Ohrlein, Rheinfelden-Herten (DE); Gabriele Baisch, Binzen (DE)

Correspondence Address: JoAnn Villamizar;Ciba Corporation/Patent Department, 540 White Plains Road, P.O. Box 2005, Tarrytown, NY, 10591, US

(21) Appl. No.: 11/885,601

(22) PCT Filed: Feb. 27, 2006
(86) PCT No.: PCT/EP2006/060302

§ 371 Date: Aug. 31, 2007

(30) Foreign Application Priority Data
Mar. 8, 2005 (EP) 05101765.5
Jul. 21, 2005 (EP) 05106699.1

(51) Int. Cl. A01N 25/26; C07F 7/28; C08K 5/53

(52) U.S. Cl. 424/421; 556/13; 524/130; 977/773

(57) ABSTRACT

The present invention relates to new metal oxide nanoparticles coated with specific phosphonates, to the use of these nanoparticles as antimicrobials, especially in the home and personal care areas, to the production of such nanoparticles as well as to the new phosphonates and the corresponding process of production.

The present invention relates to new metal oxide nanoparticles coated with specific phosphonates, to the use of these nanoparticles as antimicrobials, especially in the home and personal care areas, to the production of such nanoparticles as well as to the new phosphonates and the corresponding process of production.

Metal oxide nanoparticles coated with phosphonates of formula (I)

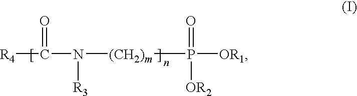

wherein
R₁ and R₂ are independently from each other hydrogen or linear C₁-C₆alkyl or branched C₃-C₆alkyl,
R₃ is hydrogen or C₁-C₄alkyl,
R₄ is linear or branched C₁-C₃₂alkyl, which can be substituted by one or more substituent chosen from the group consisting of halogen, nitrile, azido, COOR₅, NR₆R₇, CONHR₈ or OR₉,
   wherein R₅, R₆, R₇, R₈ and R₉ are independently from each other hydrogen, linear or branched C₁-C₃₂alkyl, linear or branched C₂-C₃₂alkenyl, phenyl or C₁-C₄alkylene-phenyl,
   linear or branched C₂-C₃₂alkenyl, which can be substituted by one or more substituent chosen from the group consisting of halogen, nitrile, azido, COOR₅, NR₆R₇, CONHR₈ or OR₉,
      wherein R₅, R₆, R₇, R₈ and R₉ have the same meanings as defined above, or R₄ is a moiety of formula (a)

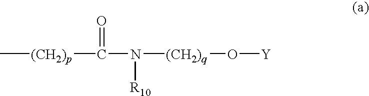

wherein
R₁₀ is hydrogen or C₁-C₄alkyl,
Y is α- or β-hexo-furanosides or pyranosides, like ribose, arabinose, xylose, lyxose, glucose, galactose, mannose; or disaccharides, like maltose, lactose, 2-N-acetyllactose, cellobiose as well as derivatives thereof,
p is an integer from 1 to 8, preferably from 1 to 4,
q is an integer from 1 to 16, preferably from 2 to 6,
n is 0 or 1 and
m is an integer from 1 to 8, preferably from 2 to 4.

The phosphonates of formula (I) are bound to the metal oxide via a covalent bond. Usually, it is a covalent bond between one, two or even all oxygen atoms of the phosphonate group with the metal oxide nanoparticle.

Preferred are metal oxide nanoparticles coated with phosphonates of formula (I)

wherein
R₁ and R₂ are independently from each other hydrogen or linear C₁-C₄alkyl or branched C₃-C₆alkyl,
R₃ is hydrogen or CH₃,
R₄ is linear or branched C₁-C₂₆alkyl, which can be substituted by one or more substituent chosen from the group consisting of halogen, nitrile, azido, COOR₅, NR₆R₇, CONHR₈ or OR₉,
   wherein R₅, R₆, R₇, R₈ and R₉ are independently from each other hydrogen, linear or branched C₁-C₂₀alkyl, linear or branched C₂-C₂₀alkenyl, phenyl or C₁-C₄alkylene-phenyl,
   linear or branched C₂-C₂₆alkenyl, which can be substituted by one or more substituent chosen from the group consisting of halogen, nitrile, azido, COOR₅, NR₆R₇, CONHR₈ or OR₉,
      wherein R₅, R₆, R₇, R₈ and R₉ have the same meanings as defined above, or R₄ is a moiety of formula (a)

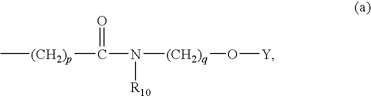

wherein
R₁₀ is hydrogen or C₁-C₂alkyl,
Y is α- or β-hexo-furanosides or pyranosides, like ribose, arabinose, xylose, lyxose, glucose, galactose, mannose; or disaccharides, like maltose, lactose, 2-N-acetyllactose, cellobiose as well as derivatives thereof,
p is an integer from 1 to 4,
q is an integer from 2 to 6,
n is 0 or 1 and
m is an integer from 2 to 4.

More preferred are metal oxide nanoparticles (covalently) coated with phosphonates of formula (I)

wherein
R₁ and R₂ are independently from each other hydrogen or linear C₁-C₂alkyl or branched C₃-C₆alkyl,
R₃ is hydrogen,
R₄ is linear or branched C₁-C₂₂alkyl, which can be substituted by one or more substituent chosen from the group consisting of Cl, F, Br, nitrile, azido, COOR₅, NR₆R₇, CONHR₈ or OR₉,
   wherein R₅, R₆, R₇, R₈ and R₉ are independently from each other hydrogen, linear or branched C₁-C₁₀alkyl, linear or branched C₂-C₁₀alkenyl, phenyl or C₁-C₂alkylene-phenyl,
   linear or branched C₂-C₂₂alkenyl, which can be substituted by one or more substituent chosen from the group consisting of halogen, nitrile, azido, COOR₅, NR₆R₇, CONHR₈ or OR₉,
      wherein R₅, R₆, R₇, R₈ and R₉ have the same meanings as defined above, or R₄ is a moiety of formula (a)

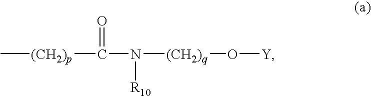

wherein
R₁₀ is hydrogen,
Y is α- or β-hexo-furanosides or pyranosides, like ribose, arabinose, xylose, lyxose, glucose, galactose, mannose; or disaccharides, like maltose, lactose, 2-N-acetyllactose, cellobiose as well as derivatives thereof,
p is an integer from 1 to 4,
q is an integer from 2 to 6,
n is 0 or 1 and
m is an integer from 2 to 4.

The metal oxide particles are preferably oxides of titanium, zirconium, silicon, aluminium or tin, more preferably titanium and zirconium and especially preferably titanium.

The average particle sizes of the metal oxide particles are from 2 to 500 nm, preferably from 10 to 500 nm and more preferably from 15 to 500 nm as measured by standard analytical protocols like TEM or SEM.

The phosphonates of formula (I) are present in an amount of 5-500 μmol per gram solid particle, preferably 80-500 μmol, determined either by quantitative FT-IR or elemental analysis of carbon, phosphorous or hydrogen.

A further embodiment of the present invention are phosphonates of formula (I)

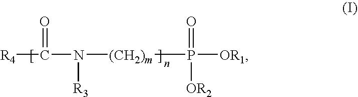

wherein
R₁ and R₂ are independently from each other hydrogen or linear C₁-C₆alkyl or branched C₃-C₆alkyl,
R₃ is hydrogen or C₁-C₄alkyl,
R₄ is linear or branched C₁-C₃₂alkyl, which can be substituted by one or more substituent chosen from the group consisting of halogen, nitrile, azido, COOR₅, NR₆R₇, CONHR₈ or OR₉,
   wherein R₅, R₆, R₇, R₈ and R₉ are independently from each other hydrogen, linear or branched C₁-C₃₂alkyl, linear or branched C₂-C₃₂alkenyl, phenyl or C₁-C₄alkylene-phenyl,
   linear or branched C₂-C₃₂alkenyl, which can be substituted by one or more substituent chosen from the group consisting of halogen, nitrile, azido, COOR₅, NR₆R₇, CONHR₈ or OR₉,
      wherein R₅, R₆, R₇, R₈ and R₉ have the same meanings as defined above,
   or R₄ is a moiety of formula (a)

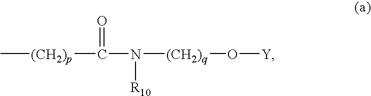

wherein
R₁₀ is hydrogen or C₁-C₄alkyl,
Y is α- or β-hexo-furanosides or pyranosides, like ribose, arabinose, xylose, lyxose, glucose, galactose, mannose; or disaccharides, like maltose, lactose, 2-N-acetyllactose, cellobiose as well as derivatives thereof,
p is an integer from 1 to 8, preferably from 1 to 4,
q is an integer from 1 to 16, preferably from 2 to 6,
n is 0 or 1 and
m is an integer from 1 to 8, preferably from 2 to 4.

Preferred are phosphonates of formula (I)

wherein
R₁ and R₂ are independently from each other hydrogen or linear C₁-C₄alkyl or branched C₃-C₆alkyl,
R₃ is hydrogen or CH₃,
R₄ is linear or branched C₁-C₂₆alkyl, which can be substituted by one or more substituent chosen from the group consisting of halogen, nitrile, azido, COOR₅, NR₆R₇, CONHR₈ or OR₉,
   wherein R₅, R₆, R₇, R₈ and R₉ are independently from each other hydrogen, linear or branched C₁-C₂₀ alkyl, linear or branched C₂-C₂₀alkenyl, phenyl or C₁-C₄alkylene-phenyl,
   linear or branched C₂-C₂₆ alkenyl, which can be substituted by one or more substituent chosen from the group consisting of halogen, nitrile, azido, COOR₅, NR₆R₇, CONHR₈ or OR₉,
      wherein R₅, R₆, R₇, R₈ and R₉ have the same meanings as defined above, or R₄ is a moiety of formula (a)

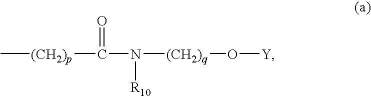

wherein
R₁₀ is hydrogen or C₁-C₂alkyl,
Y is α- or β-hexo-furanosides or pyranosides, like ribose, arabinose, xylose, lyxose, glucose, galactose, mannose; or disaccharides, like maltose, lactose, 2-N-acetyllactose, cellobiose as well as derivatives thereof,
p is an integer from 1 to 4,
q is an integer from 2 to 6,
n is 0 or 1 and
m is an integer from 2 to 4.

More preferred are phosphonates of formula (I)

wherein
R₁ and R₂ are independently from each other hydrogen or linear C₁-C₂alkyl or branched C₃-C₆alkyl,
R₃ is hydrogen,
R₄ is linear or branched C₁-C₂₂alkyl, which can be substituted by one or more substituent chosen from the group consisting of Cl, F, Br, nitrile, azido, COOR₅, NR₆R₇, CONHR₈ or OR₉,
   wherein R₅, R₆, R₇, R₈ and R₉ are independently from each other hydrogen, linear or branched C₁-C₁₀alkyl, linear or branched C₂-C₁₀alkenyl, phenyl or C₁-C₂alkylene-phenyl,
   linear or branched C₂-C₂₂ alkenyl, which can be substituted by one or more substituent chosen from the group consisting of halogen, nitrile, azido, COOR₅, NR₆R₇, CONHR₈ or OR₉,
      wherein R₅, R₆, R₇, R₈ and R₉ have the same meanings as defined above, or R₄ is a moiety of formula (a)

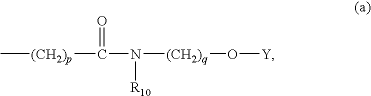

wherein
R₁₀ is hydrogen,
Y is α- or β-hexo-furanosides or pyranosides, like ribose, arabinose, xylose, lyxose, glucose, galactose, mannose; or disaccharides, like maltose, lactose, 2-N-acetyllactose, cellobiose as well as derivatives thereof,
p is an integer from 1 to 4,
q is an integer from 2 to 6,
n is 0 or 1 and
m is an integer from 2 to 4.

A further embodiment is the process of production of the phosphonates of formula (Ia), which correspond to compounds of formula (I) wherein n is 1. All substituents have the meanings as defined in formula (I).

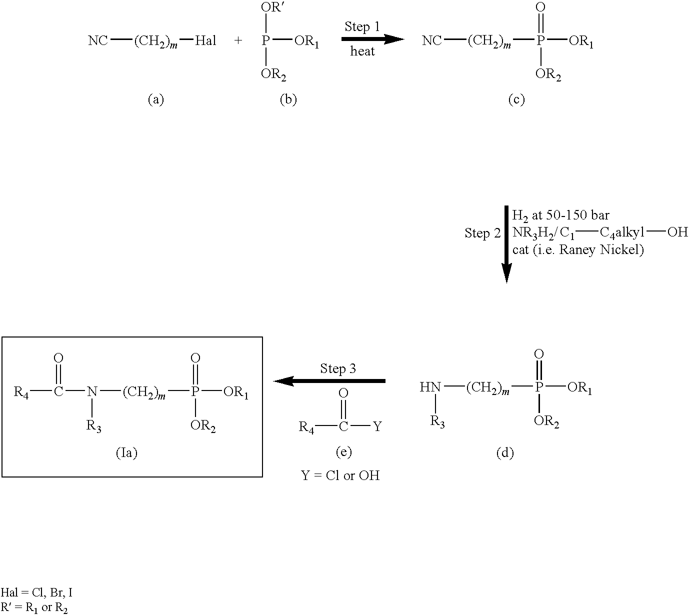

The reaction of step 1 is carried out at elevated temperature. (preferably from 40° C. to 180° C.). The phosphite of formula (b) is preferably added in an excess. Inert solvents like toluene or linear or cyclic ethers may be used, correspondingly. Such a reaction is described for example in A. Arbuzov, Pure&Appl. Chem. 1964, 9, p. 307.

The obtained reaction product of formula (c) is subsequently reduced in protic solvents in step 2. Preferred protic solvents are methanol, ethanol, propanol, butanol or iso-propanol. The reaction solution of step 2 also contains ammonia as cosolvent from 5-15 weight-% (wt.-%)

The reduction is carried out at 50-150 bar of hydrogen pressure in the presence of a metal catalyst like Raney Nickel, iron, platinum, palladium or ruthenium (preferably Raney-Nickel). In a third step, the amines (d) are reacted with carbonic acids or acid chlorides (e) in the presence of an organic or inorganic base to scavenge the liberated hydrochloric acid or in the presence of an additional appropriate coupling auxiliary (M. Bodansky, Principles of Peptide Synthesis, 2^{nd} ed. Springer 1993, ISBN 0-387-56431-4) when a carbonic acid is used to form the amides (Ia), respectively.

An alternative way to produce phosphonates of formula (Ia) is the following process

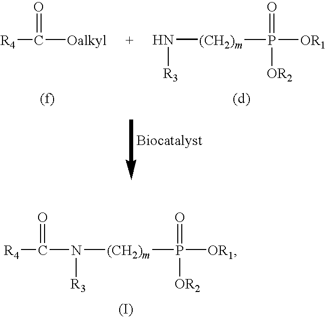

wherein all substituents have the meanings as defined in formula (I).

Such a process is known from the literature, for example from V. Alfaro et al. Biotechnol. Lett. 2000, 22, 575.

A further embodiment of the present invention is a process of production of phosphonates of formula (Ib), which correspond to compounds of formula (I) wherein n is 0. All substituents have the meanings as defined in formula (I). The starting alkyl halides may be commercially available or prepared according to the literature starting from the corresponding available alcohols (J. March 3^{rd} ed. 1985, John Wiley ISBN 0-471-85472-7).

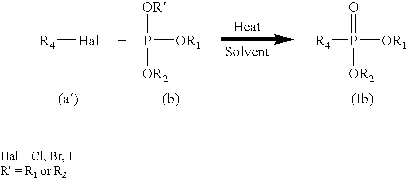

A further embodiment of the present invention is the process of production of the metal oxide nanoparticles coated with phosphonates of formula (I), wherein the metal oxides are mixed with the phosphonates of formula (I) in an organic solvent at elevated temperature. Preferably, the temperature in a such a process is from 40° C. to 150° C., more preferably from 80° to 125° C.

Suitable organic solvents are toluene, benzene, xylene, hexane, heptane, cyclohexane or other linear or branched aliphatic or aromatic solvents; or linear or branched alcohols like methanol, ethanol, propanol, butanol, isopropanol, tert. amylalcohol; or linear, branched or cyclic ethers like methyl-tert.butyl ether, dibutyl ether, tetrahydrofuran or dioxane and the like or mixtures of the solvents stated above.

Unbound phosphonate precursors are removed by centrifugation or extensive soxhlet-extraction with an appropriate organic solvent. The coated particles are thoroughly dried to remove any adhering solvent and subject to elemental analysis and the bioassays.

A further embodiment of the present invention is the use of the metal oxide nanoparticles coated with phosphonates of formula (I) as antimicrobials. Antimicrobials are substances that exhibit a pronounced antimicrobial action, especially against pathogenic gram-positive and gram-negative bacteria and also against bacteria of skin flora, e.g. Corynebacterium xerosis (bacteria that cause body odor), and also against yeasts and moulds.

This present invention therefore relates to the use of an antimicrobially effective amount of at least one metal oxide nanoparticle coated with phosphonates of formula (I) in personal care preparations.

The metal oxide nanoparticles coated with phosphonates of formula (I) as described above are found to be very useful as antimicrobials in many personal care compositions such as hair care and skin care compositions. These compositions will generally comprise at least one cosmetically-functional agent used in an amount effective to impart desired cosmetic properties to the personal care composition. The term “cosmetically-functional agent”, as used herein, means any material, compound or composition applied to the hair or skin for cosmetic application thereof. Exemplary agents include emollients, humectants, lubricants, UV-light inhibitors, preservatives, pigments, dyes, colorants, alpha-hydroxy acids, aesthetic enhancers such as starch, perfumes and fragrances, film formers (water proofing agent), antiseptics, antifungal, antimicrobial and other medicaments, solvents, surfactants, natural or synthetic polymers, hair conditioning agents and hair fixatives. Such cosmetically-functional agents include mineral oils, glycerin, beeswax, lanolin, acetylated lanolin, stearic acid, palmitic acid, cetyl alcohol, sodium salts of olefin sulfonates, various proteins, polymeric sugars, conditioning agents such as polyquaternium and hair fixatives such as poly(vinyl pyrrolidone) and N-vinyl formamide or polyvinyl formamide.

The cosmetically-functional agent may be present in the personal care composition in an amount of up to 60 weight percent based on the total weight of the personal care composition.

The personal care preparation according to the invention comprises from 0.01 to 15 wt.-%, preferably from 0.5 to 10 wt.-%, based on the total weight of the composition, of at least one metal oxide nanoparticles coated with phosphonates of formula (I) and cosmetically tolerable adjuvants.

Personal care compositions are for example shampoos, bath- and shower additives, hair-care products, wax/fat compositions, liquid soaps, lotions, gels, crèmes, deodorants, stick preparations, powders, ointments, other aqueous or alcoholic or aqueous/alcoholic solutions, for example cleaning solutions for the skin, moist cleaning sheets and oils.

Personal care compositions include a very wide range of products. Suitable products are, for example, especially the following:
skin-care products, for example skin washing and cleansing products in the form of bars of soap or liquid soaps, syndets or washing pastes,
bath products, for example liquid (foam baths, milks, shower products) or solid bath products, such as bath pearls and bath salts;
skin-care products, such as skin emulsions, multiple emulsions or skin oils;
decorative body-care products, for example face make-ups in the form of day or powder creams, face powders (lose and compressed), rouge or cream make-ups, eye-care products, for example eye shadow products, mascara, eyeliners, eye creams or eye-fix creams; lip-care products, for example lipstick, lip gloss, lip liner, nail-care products, such as nail varnish, nail varnish remover, nail hardeners or cuticle removers;
feminine hygiene products, such as feminine hygiene washing lotions or sprays;
foot-care products, for example foot baths, foot powders, food creams or foot balms, special deodorants and antiperspirants or products for scrubbing off callouses;
sunscreens, such as sun milks, lotions, creams, oils, sunblockers or tropicals, pre-sun products or after-sun products;
suntanning products, for example self-tanning creams;
depigmenting products, for example products for bleaching or lightening skin;
insect repellents, for example insect oils, lotions, sprays or sticks;
deodorants, for example deodorant sprays, non-aerosol sprays, deodorant gels, sticks or roll-ons;
antiperspirants, for example antiperspirant sticks, creams or roll-ons;
products for cleansing and treating impure skin, for example syndets (solid or liquid), peeling or scrubbing products or peeling masks;
chemical depilatory products, for example depilatory powders, liquid depilatory products, creamy or pasty depilatory products, depilatory gels or aerosol foams;
shaving products, for example shaving soap, foaming shaving creams, non-foaming shaving creams, shaving foams and gels, preshaving products for dry shaving, aftershaves or aftershave lotions;
scents, for example perfumes (Eau de Cologne, Eau de Toilette, Eau de Parfum, Parfum de Toilette, perfume), perfume oils or perfume creams;
products for oral and dental hygiene as well as for dentures, for example toothpastes, tooth gels, tooth powders, mouth-wash concentrates, anti-plaque mouth-washes, denture cleaning products or denture adhesion products;
cosmetic formulations for hair treatment, for example hair washes in the form of shampoos, hair conditioners, hair-care products, for example pretreatment products, hair tonics, hair styling creams and gels, pomades, hair rinses, deep conditioning treatments, intensive hair care treatments, hair setting products, for example waving agents for perms (hot wave, mild wave, cold wave), hair straightening products, liquid hair fixatives, hair foams, hair sprays, bleaching agents, for example hydrogen peroxide solutions, bleaching shampoos, bleaching creams, bleaching powders, bleaching pastes or oils, temporary, semi-temporary or permanent hair dyes, products containing self-oxidizing dyes, or natural hair dyes, such as henna or camomile.

The personal care compositions listed above can be in a very wide range of forms of presentation, for example
in the form of liquid formulations as an oil-in-water (O/W) emulsion,
in the form of a gel,
in the form of an oil, cream, milk or lotion,
in the form of a powder, lacquer, pellets or make-up,
in the form of a stick or bar,
in the form of a spray (spray with propellant or pumping spray) or an aerosol,
in the form of a foam, or
in the form of a paste.

When the personal care composition is a liquid formulation in the form of an oil-in-water (O/W) emulsion, the oil phase (oil-component) can be chosen from the following substance groups without limiting the kind of lipophilic ingredient to those substances:

### Fatty Alcohols:

Guerbet alcohols based on fatty alcohols having from 6 to 18, preferably from 8 to 10 carbon atoms including cetyl alcohol, stearyl alcohol, cetearyl alcohol, oleyl alcohol, octyidodecanol, benzoates of C₁₂-C₁₅ alcohols, acetylated lanolin alcohol, etc.

### Esters of Fatty Acids:

Esters of linear C₆-C₂₄ fatty acids with linear C₃-C₂₄ alcohols, esters of branched C₆-C₁₃-carboxylic acids with linear C₆-C₂₄ fatty alcohols, esters of linear C₆-C₂₄ fatty acids with branched alcohols, especially 2-ethylhexanol, esters of hydroxycarboxylic acids with linear or branched C₆-C₂₂ fatty alcohols, especially dioctyl malates, esters of linear and/or branched fatty acids with polyhydric alcohols (for example propylene glycol, dimer diol or trimer triol) and/or Guerbet alcohols, for example caproic acid, caprylic acid, 2-ethylhexanoic acid, capric acid, lauric acid, isotridecanoic acid, myristic acid, palmitic acid, palmitoleic acid, stearic acid, isostearic acid, oleic acid, elaidic acid, petroselinic acid, linoleic acid, linolenic acid, elaeostearic acid, arachidic acid, gadoleic acid, behenic acid and erucic acid and technical-grade mixtures thereof (obtained, for example, in the pressure removal of natural fats and oils, in the reduction of aldehydes from Roelen's oxosynthesis or in the dimerization of unsaturated fatty acids) with alcohols, for example, isopropyl alcohol, caproic alcohol, capryl alcohol, 2-ethylhexyl alcohol, capric alcohol, lauryl alcohol, isotridecyl alcohol, myristyl alcohol, cetyl alcohol, palmoleyl alcohol, stearyl alcohol, isostearyl alcohol, oleyl alcohol, elaidyl alcohol, petroselinyl alcohol, linoyl alcohol, linolenyl alcohol, elaeostearyl alcohol, arachidyl alcohol, gadoleyl alcohol, behenyl alcohol, erucyl alcohol and brassidyl alcohol and technical-grade mixtures thereof (obtained, for example, in the high-pressure hydrogenation of technical-grade methyl esters based on fats and oils or aldehydes from Roelen's oxo-synthesis and as monomer fractions in the dimerization of unsaturated fatty alcohols).

Examples of such ester oils are isopropylmyristate, isopropylpalmitate, isopropylstearate, isopropyl isostearate, isopropyloleate, n-butylstearate, n-hexyllaurate, n-decyloleate, isooctylstearate, iso-nonylstearate, isononyl isononanoate, 2-ethylhexylpalmitate, 2-hexyllaurate, 2-hexyldecylstearate, 2-octyidodecylpalmitate, oleyloleate, oleylerucate, erucyloleate, erucylerucate, cetearyl octanoate, cetyl palmitate, cetyl stearate, cetyl oleate, cetyl behenate, cetyl acetate, myristyl myristate, myristyl behenate, myristyl oleate, myristyl stearate, myristyl palmitate, myristyl lactate, propylene glycol dicaprylate/caprate, stearyl heptanoate, diisostearyl malate, octyl hydroxystearate, etc.

Further oil components that can be used are dicarboxylic acid esters, such as diethylhexyl 2,6-naphthalate, di-n-butyl adipate, di(2-ethylhexyl)-adipate, di(2-ethylhexyl)-succinate and diisotridecyl acelate, and also diol esters, such as ethylene glycol dioleate, ethylene glycol diisotridecanoate, propylene glycol di(2-ethylhexanoate), propylene glycol diisostearate, propylene glycol dipelargonate, butanediol diisostearate and neopentyl glycol dicaprylate. Esters of C₆-C₂₄ fatty alcohols and/or Guerbet alcohols with aromatic carboxylic acids, saturated and/or unsaturated, especially benzoic acid, esters of C₂-C₁₂dicarboxylic acids with linear or branched alcohols having from 1 to 22 carbon atoms or polyols having from 2 to 10 carbon atoms and from 2 to 6 hydroxy groups.

### Natural or Synthetic Triglycerides Including Glyceryl Esters and Derivatives:

Di- or tri-glycerides, based on C₆-C₁₈ fatty acids, modified by reaction with other alcohols (caprylic/capric triglyceride, wheat germ glycerides, etc.). Fatty acid esters of polyglycerin (polyglyceryl-n such as polyglyceryl-4 caprate, polyglyceryl-2 isostearate, etc.) or castor oil (Ricinus Communis), hydrogenated vegetable oil, sweet almond oil, wheat germ oil, sesame oil, hydrogenated cottonseed oil, coconut oil, avocado oil, corn oil, hydrogenated castor oil, shea butter, cocoa butter, soybean oil, mink oil, sunflower oil, safflower oil, macadamia nut oil, olive oil, hydrogenated tallow, apricot kernel oil, hazelnut oil, borago oil, etc.

### Waxes:

This includes esters of long-chain acids and alcohols as well as compounds having wax-like properties, e.g., carnauba wax (Copernicia Cerifera), beeswax (white or yellow), lanolin wax, candellila wax (Euphorbia Cerifera), ozokerite, japan wax, paraffin wax, microcrystalline wax, ceresin, cetearyl esters wax, synthetic beeswax, etc.; also, hydrophilic waxes as cetearyl alcohol or partial glycerides.

### Pearlescent Waxes:

Alkylene glycol esters, especially ethylene glycol distearate; fatty acid alkanolamides, especially coco fatty acid diethanolamide; partial glycerides, especially stearic acid monoglyceride; esters of polyvalent, unsubstituted or hydroxy-substituted carboxylic acids with fatty alcohols having from 6 to 22 carbon atoms, especially long-chained esters of tartaric acid; fatty substances, for example fatty alcohols, fatty ketones, fatty aldehydes, fatty ethers and fatty carbonates, which in total have at least 24 carbon atoms, especially laurone and distearyl ether; fatty acids, such as stearic acid, hydroxystearic acid or behenic acid, ring-opening products of olefin epoxides having from 12 to 22 carbon atoms with fatty alcohols having from 12 to 22 carbon atoms and/or polyols having from 2 to 15 carbon atoms and from 2 to 10 hydroxy groups, and mixtures thereof.

### Hydrocarbon Oils:

Mineral oil (light or heavy), petrolatum (yellow or white), microcrystalline wax, paraffinic and isoparaffinic compounds, hydrogenated isoparaffinic molecules as polydecenes, and polybutene, hydrogenated polyisobutene, squalane, isohexadecane, isododecane and others from the plant and animal kingdom.

### Silicones or Siloxanes (Organosubstituted Polysiloxanes):

Dimethylpolysiloxanes, methylphenylpolysiloxanes, cyclic silicones, and also amino-, fatty acid-, alcohol-, polyether-, epoxy-, fluorine-, glycoside- and/or alkyl-modified silicone compounds, which at room temperature may be in either liquid or resinous form. Linear polysiloxanes: dimethicone such as Dow Corning®200 fluid, Mirasil® DM (Rhodia), dimethiconol. Cyclic silicone fluids: cyclopentasiloxanes, volatiles such as Dow Corning® 345 fluid, Silbione® grade, Abil® grade. Phenyltrimethicones; Dow Corning® 556 fluid. Also suitable are simethicones, which are mixtures of dimethicones having an average chain length of from 200 to 300 dimethylsiloxane units with hydrogenated silicates. A detailed survey by Todd et al. of suitable volatile silicones may in addition be found in Cosm. Toil. 91, 27 (1976).

### Fluorinated or Perfluorinated Oils:

Perfluorhexane, dimethylcyclohexane, ethylcyclopentane (Flutec® grades). polyperfluoromethylisopropyl ether (Fomblin® grades).

In an O/W-formulation the oil component is preferably present in an amount of from 5 wt.-% to 50 wt.-% and more preferably from 10 wt.-% to 35 wt.-%, based on the total weight of the personal care composition.

### Emulsifiers:

Any conventionally usable emulsifier can be used for the personal care compositions. Emulsifier systems may comprise for example:

Carboxylic Acids and their Salts:
Alkaline soaps of sodium, potassium and ammonium; metallic soaps of calcium or magnesium; organic basis soaps such as lauric, palmitic, stearic and oleic acid, etc. Alkyl phosphates or phosphoric acid esters: acid phosphate, diethanolamine phosphate, potassium cetyl phosphate;
ethoxylated carboxylic acids or polyethyleneglycol esters (PEG-n Acylates). Linear fatty alcohols having from 8 to 22 carbon atoms, products from 2 to 30 mol of ethylene oxide and/or from 0 to 5 mol propylene oxide with fatty acids having from 12 to 22 carbon atoms and with alkylphenols having from 8 to 15 carbon atoms in the alkyl group. Fatty alcohol polyglycolethers such as Laureth-n, Ceteareth-n, Steareth-n, Oleth-n. Fatty acid polyglycol ethers such as PEG-n Stearate, PEG-n Oleate, PEG-n Cocoate;
monoglycerides and polyol esters. C₁₂-C₂₂ fatty acid mono- and di-esters of addition products of from 1 to 30 mol of ethylene oxide with polyols; fatty acid and polyglycerol esters such as monostearate glycerol, diisostearoyl polyglyceryl-3-diisostearates, polyglyceryl-3-diisostearates, triglyceryl diisostearates, polyglyceryl-2-sesquiisostearates or polyglyceryl dimerates. Mixtures of compounds from a plurality of those substance classes are also suitable. Fatty acid polyglycol esters such as monostearate diethylene glycol, fatty acid and polyethylene glycol esters; fatty acid and saccharose esters such as sucro esters, glycerol and saccharose esters such as sucro glycerides; sorbitol and sorbitan: sorbitan mono- and di-esters of saturated and unsaturated fatty acids having from 6 to 22 carbon atoms and ethylene oxide addition products;
polysorbate-n series, sorbitan esters such as sesquiisostearate, sorbitan, PEG-(6)-isostearate sorbitan, PEG-(10)-laurate sorbitan, PEG-17-dioleate sorbitan;
glucose derivatives: C₈-C₂₂ alkyl-mono and oligo-glycosides and ethoxylated analogues with glucose being preferred as the sugar component. O/W emulsifiers such as methyl gluceth-20 sesquistearate, sorbitan stearate/sucrose cocoate, methyl glucose sesquistearate, cetearyl alcohol/cetearyl glucoside. W/O emulsifiers such as methyl glucose dioleate/methyl glucose isostearate.

### Sulfates and Sulfonated Derivatives:

Dialkylsulfosuccinates (for example DOSS: dioctyl succinate), alkyl lauryl sulfonate, linear sulfonated paraffins, sulfonated tetrapropylene sulfonate, sodium lauryl sulfates, ammonium and ethanolamine lauryl sulfates, lauryl ether sulfates, sodium laureth sulfates, sulfosuccinates, acetyl isothionates, alkanolamide sulfates such as taurines, methyl taurines, imidazole sulfates.

### Amine Derivatives:

Amine salts, ethoxylated amines such as oxide amine, with chains containing a heterocycle such as alkyl imidazolines, pyridine derivatives, isoquinolines, cetyl pyridinium chloride, cetyl pyridinium bromide, quaternary ammoniums such as cetyltrimethylammonium bromide, Stearylalkonium.

Amide derivatives: alkanolamides such as acylamide DEA, ethoxylated amides, such as PEG-n acylamide, oxydeamide.

Polysiloxane/polyalkyl/polyether copolymers and derivatives: dimethicone, copolyols, silicone polyethylene oxide copolymers and silicone glycol copolymers;

Propoxylated or POE-n ethers (Meroxapols), Polaxamers or poly(oxyethylene)m-block-poly(oxypropylene)n-block(oxyethylene) copolymers.

Zwitterionic surfactants that carry at least one quaternary ammonium group and at least one carboxylate and/or sulfonate group in the molecule. Zwitterionic surfactants that are especially suitable are the so-called betaines, such as N-alkyl-N,N-dimethylammonium glycinates, for example cocoalkyldimethylammonium glycinate, N-acylaminopropyl-N,N-dimethylammonium glycinates, for example cocoacylaminopropyldimethylammonium glycinate, and 2-alkyl-3-carboxymethyl-3-hydroxyethylimidazolines each having from 8 to 18 carbon atoms in the alkyl or acyl group and also cocoacylaminoethylhydroxyethyl-carboxy-methylglycinate, N-alkylbetaine and N-alkylaminobetaines;

Alkylimidazolines, alkylopeptides and lipoaminoacids;
Self emulsifying bases (see K. F. DePolo—A Short Textbook Of Cosmetology, Chapter 8, Table 8-7, p 250-251);
Non ionic bases such as PEG-6 Beeswax (and) PEG-6 Stearate (and) polyglyceryl-2 isostearate [Apifac], Glyceryl stearate (and) PEG-100 stearate. [Arlacel 165], PEG-5 Glyceryl stearate [Arlatone 983 S], Sorbitan oleate (and) Polyglyceryl-3 Ricinoleate [Arlacel 1689], sorbitan stearate and sucrose cocoate [Arlatone 2121], Glyceryl stearate and laureth-23 [Cerasynth 945], cetearyl alcohol and Ceteth-20 [Cetomacrogol Wax], cetearyl alcohol and Polysorbate 60 and PEG-150 and stearate-20 [Polawax GP 200, Polawax NF], cetearyl alcohol and cetearyl polyglucoside [Emulgade PL 1618], cetearyl alcohol and Ceteareth-20 [Emulgade 1000NI, Cosmowax], cetearyl alcohol and PEG-40 castor oil [Emulgade F Special], cetearyl Alcohol and PEG-40 castor oil and sodium cetearyl sulfate [Emulgade F], stearyl alcohol and Steareth-7 and Steareth-10 [Emulgator E 2155], cetearyl Alcohol and Steareth-7 and Steareth-10 [Emulsifying wax U.S.N.F], glyceryl stearate and PEG-75 stearate [Gelot 64], propylene glycol ceteth-3 acetate [Hetester PCS], propylene glycol isoceth-3 acetate [Hetester PHA], cetearyl alcohol and Ceteth-12 and Oleth-12 [Lanbritol Wax N 21], PEG-6 stearate and PEG-32 stearate [Tefose 1500], PEG-6 stearate and Ceteth-20 and Steareth-20 [Tefose 2000], PEG-6 Stearate and ceteth-20 and Glyceryl Stearate and steareth-20 [Tefose 2561], glyceryl stearate and Ceteareth-20 [Teginacid H. C, X];
Anionic alkaline bases such as PEG-2 stearate SE, glyceryl stearate SE [Monelgine, Cutina KD] and propylene glycol stearate [Tegin P];
Anionic acid bases such as cetearyl alcohol and sodium cetearyl sulfate [Lanette N, Cutina LE, Crodacol GP], cetearyl alcohol and sodium lauryl sulfate [Lanette W], Trilaneth-4 phosphate and glycol stearate and PEG-2 stearate [Sedefos 75], glyceryl stearate and sodium lauryl sulfate [Teginacid Special]; and
Cationic acid bases such as cetearyl alcohol and cetrimonium bromide.

The emulsifiers may be used in an amount of, for example, from 1 wt.-% to 30 wt.-%, especially from 4 wt.-% to 20 wt.-% and preferably from 5 wt.-% to 10 wt.-%, based on the total weight of the composition.

When formulated in O/W emulsions, the amount of the emulsifier system preferably represents 5 wt.-% to 20 wt.-% of the oil phase.

### Adjuvants and Additives:

The personal care compositions, for example creams, gels, lotions, alcoholic and aqueous/alcoholic solutions, emulsions, wax/fat compositions, stick preparations, powders or ointments, may in addition contain, as further adjuvants and additives, mild surfactants, super-fatting agents, consistency regulators, additional thickeners, polymers, stabilizers, biogenic active ingredients, deodorizing active ingredients, anti-dandruff agents, film formers, swelling agents, further UV light-protective factors, antioxidants, hydrotropic agents, preservatives, insect repellents, self-tanning agents, solubilizers, perfume oils, colourants, bacteria-inhibiting agents and the like.

The adjuvants and additives may optionally be present in the personal care composition in an amount of, for example, from 0.1 wt.-% to 25 wt.-% based on the total weight of the composition.

### Super-Fatting Agents:

Substances suitable for use as super-fatting agents are, for example, lanolin and lecithin and also polyethoxylated or acrylated lanolin and lecithin derivatives, polyol fatty acid esters, monoglycerides and fatty acid alkanolamides, the latter simultaneously acting as foam stabilizers.

### Surfactants:

Examples of suitable mild surfactants, that is to say surfactants especially well tolerated by the skin, include fatty alcohol polyglycol ether sulfates, monoglyceride sulfates, mono- and/or di-alkyl sulfosuccinates, fatty acid isothionates, fatty acid sarcosinates, fatty acid taurides, fatty acid glutamates, α-olefin sulfonates, ethercarboxylic acids, alkyl oligoglucosides, fatty acid glucamides, alkylamidobetaines and/or protein fatty acid condensation products, the latter preferably being based on wheat proteins.

### Consistency Regulators/Additional Thickeners and Rheology Modifiers:

As additional thickeners and rheology modifiers, there come into consideration the groups of silicium dioxide, magnesium silicates, aluminium silicates, polysaccharides or derivatives thereof, for example hyaluronic acid, xanthan gum, guar-guar, agar-agar, alginates, Carraghenan, gellan, pectins, or modified cellulose such as hydroxycellulose and hydroxypropylmethylcellulose. In addition polyacrylates or homopolymer of reticulated acrylic acids and polyacrylamides, e.g. the Carbopol range (e.g. Carbopol types 980, 981, 1382, ETD 2001, ETD2020, Ultrez 10; INCI: Carbomer) or the Ciba Salcare® range such as Salcare® SC80 (Steareth-10 alkyl ether/acrylates copolymer), Salcare® SC81 (acrylates copolymer), Salcare® SC91 and Salcare® AST (sodium acrylates copolymer/PPG-1 trideceth-6), Sepigel 305 (polyacrylamide/laureth-7), Simulgel NS and Simulgel EG (hydroxyethyl acrylate/sodium acryloyidimethyl taurate copolymer), Stabilen 30 (acrylates/vinyl isodecanoate crosspolymer), Pemulen TR-1 (acrylates/C₁₀-C₃₀ alkyl acrylate crosspolymer), Luvigel EM (sodium acrylates copolymer), Aculyn 28 (acrylates/beheneth-25 methacrylate copolymer), etc.

### Polymers:

Suitable cationic polymers are, for example, cationic cellulose derivatives, for example a quaternized hydroxymethyl cellulose obtainable under the name Polymer JR 400® from Amerchol, cationic starches, copolymers of diallylammonium salts and acrylamides, quaternized vinylpyrrolidone/vinyl imidazole polymers, for example Luviquat® (BASF), condensation products of polyglycols and amines, quaternized collagen polypeptides, for example lauryidimonium hydroxypropyl hydrolyzed collagen (Lamequat® L/Grünau), quaternized wheat polypeptides, polyethyleneimine, cationic silicone polymers, for example amidomethicones, copolymers of adipic acid and dimethylaminohydroxypropyldiethylenetriamine (Cartaretin®/Clariant), copolymers of acrylic acid with dimethyldiallylammonium chloride (Merquat® 550/Chemviron), polyaminopolyamides, as described, for example, in FR-A-2 252 840, and the cross-linked water-soluble polymers thereof, cationic chitin derivatives, for example of quaternized chitosan, optionally distributed as microcrystals; condensation products of dihaloalkyls, for example dibromobutane, with bisdialkylamines, for example bisdimethylamino-1,3-propane, cationic guar gum, for example Jaguar® C-17, Jaguar® C-16 from Celanese, quaternized ammonium salt polymers, for example Mirapol®A-15, Mirapol®AD-1, Mirapol® AZ-1 from Miranol. As anionic, zwitterionic, amphoteric and non-ionic polymers there come into consideration, for example, vinyl acetate/crotonic acid copolymers, vinylpyrrolidone/vinyl acrylate copolymers, vinyl acetate/butyl maleate/isobornyl acrylate copolymers, methyl vinyl ether/maleic anhydride copolymers and esters thereof, uncrosslinked polyacrylic acids and polyacrylic acids cross linked with polyols, acrylamidopropyltrimethylammonium chloride/acrylate copolymers, octyl acrylamide/methyl methacrylate/tert-butylaminoethyl methacrylate/2-hydroxypropyl methacrylate copolymers, polyvinylpyrrolidone, vinyl pyrrolidone/vinyl acetate copolymers, vinyl pyrrolidone/dimethyl-aminoethyl methacrylate/vinyl caprolactam terpolymers and also optionally derivatized cellulose ethers and silicones. Furthermore the polymers as described in EP 1093796 (pages 3-8, paragraphs 17-68) may be used.

### Biogenic Active Ingredients:

Biogenic active ingredients are to be understood as meaning, for example, tocopherol, tocopherol acetate, tocopherol palmitate, ascorbic acid, deoxyribonucleic acid, retinol, bisabolol, allantoin, phytantriol, panthenol, AHA acids, amino acids, ceramides, pseudoceramides, essential oils, plant extracts and vitamin complexes.

### Deodorizing Active Ingredients:

As deodorizing active ingredients there come into consideration, for example, antiperspirants, for example aluminum chlorohydrates (see J. Soc. Cosm. Chem. 24, 281 (1973)). Under the trade mark Locron® of Clariant, there is available commercially, for example, an aluminum chlorohydrate corresponding to formula Al₂(OH)₅Cl×2.5H₂O, the use of which is especially preferred (see J. Pharm. Pharmacol. 26, 531 (1975)). Besides the chlorohydrates, it is also possible to use aluminum hydroxyacetates and acidic aluminum/zirconium salts. Esterase inhibitors may be added as further deodorizing active ingredients. Such inhibitors are preferably trialkyl citrates, such as trimethyl citrate, tripropyl citrate, triisopropyl citrate, tributyl citrate and especially triethyl citrate (Hydagen® CAT, Henkel KGaA, Düsseldorf/GER), which inhibit enzyme activity and hence reduce odor formation. Further substances that come into consideration as esterase inhibitors are sterol sulfates or phosphates, for example lanosterol, cholesterol, campesterol, stigmasterol and sitosterol sulfate or phosphate, dicarboxylic acids and esters thereof, for example glutaric acid, glutaric acid monoethyl ester, glutaric acid diethyl ester, adipic acid, adipic acid monoethyl ester, adipic acid diethyl ester, malonic acid and malonic acid diethyl ester and hydroxycarboxylic acids and esters thereof, for example citric acid, malic acid, tartaric acid or tartaric acid diethyl ester. Additional antibacterial active ingredients that influence the germ flora and kill or inhibit the growth of sweat-decomposing bacteria can likewise be present in the preparations (especially in deodorant stick preparations). Examples include chitosan, phenoxyethanol and chlorhexidine gluconate. 5-Chloro-2-(2,4-dichlorophenoxy)-phenol (Irgasan® DP 300, Ciba Specialty Chemicals Inc.) has proved especially effective.

### Anti-Dandruff Agents:

As anti-dandruff agents there may be used, for example, climbazole, octopirox and zinc pyrithione.

Customary film formers include, for example, chitosan, microcrystalline chitosan, quaternized chitosan, polyvinylpyrrolidone, vinylpyrrolidone/vinyl acetate copolymers, polymers of quaternary cellulose derivatives containing a high proportion of acrylic acid, collagen, hyaluronic acid and salts thereof and similar compounds.

### Antioxidants:

The personal care product can optionally contain one or more antioxidants. Any common antioxidant can be used. Typical examples of such antioxidants are 4,4′-di-α-cumyl-diphenylamine, mono- and dialkylated tert-butyl/tert-octyl-diphenylamines, n-octadecyl 3,5-di-tert-butyl-4-hydroxyhydrocinnamate, tetradibutyl pentaerythrityl-4-hydroxyhydrocinnamate, neopentanetetrayl tetrakis(3,5-di-tert-butyl-4-hydroxyhydrocinammate), di-n-octa-decyl 3,5-di-tert-butyl-4-hydroxybenzylphosphonate, 1,3,5-tris(3,5-di-tert-butyl-4-hydroxybenzyl)isocyanurate thiodiethylene bis(3,5-di-tert-butyl-4-hydroxyhydro-cinnamate), 1,3,5-trimethyl-2,4,6-tris(3,5-di-tert-butyl-4-hydroxybenzyl)benzene, 3,6-dioxaoctamethylene bis(3-methyl-5-tert-butyl-4-hydroxyhydrocinnamate), 2,6-di-tert-butyl-p-cresol, 2,2′-ethylidene-bis(4,6-di-tert-butylphenol), 1,3,5-tris(2,6-dimethyl-4-tert-butyl-3-hydroxybenzyl) isocynurate, 1,1,3-tris(2-methyl-4-hydroxy-5-tert-butyl-phenyl)butane, 1,3,5-tris[2-(3,5-di-tert-butyl-4-hydroxyhydrocinnamoyloxy)ethyl] iso-cyanurate, 3,5-di-(3,5-di-tert-butyl-4-hydroxybenzyl)mesitol, hexamethylene bis(3,5-di-tert-butyl-4-hydroxyhydrocinnamate), 1-(3,5-di-tert-butyl-4-hydroxyanilino)-3,5-di(octylthio)-s-triazine, N N′-hexamethylene-bis(3,5-di-tert-butyl-4-hydroxyhydro-cinnamamide), calcium bis(ethyl 3,5-di-tert-butyl-4-hydroxybenzylphosphonate), ethylene bis[3,3-di(3-tert-butyl-4-hydroxyphenyl)butyrate], octyl 3,5-di-tert-butyl-4-hydroxybenzyl mercaptoacetate, bis(3,5-di-tert-butyl-4-hydroxyhydrocinnamoyl)-hydrazide, N N′-bis[2-(3,5-di-tert-butyl-4-hydroxyhydrocinnamoyloxy)-ethyl]oxamide, and N,N-dialkylhydroxylamine prepared from di(hydrogenated tallow)amine by direct oxidation.

Further suitable antioxidants are amino acids (e.g. glycine, histidine, tyrosine, tryptophan) and derivatives thereof, imidazoles (e.g. urocanic acid) and derivatives thereof, peptides, such as D,L-carnosine, D-carnosine, L-carnosine and derivatives thereof (e.g. anserine), carotinoids, carotenes (e.g. α-carotene, β-carotene, lycopene) and derivatives thereof, chlorogenic acid and derivatives thereof, lipoic acid and derivatives thereof (e.g. dihydrolipoic acid), aurothioglycose, propylthiouracil and other thiols (e.g. thioredoxin, glutathione, cysteine, cystine, cystamine and the glycosyl, N-acetyl, methyl, ethyl, propyl, amyl, butyl, lauryl, palmitoyl, oleyl, linoleyl, cholesteryl and glyceryl esters thereof) and also salts thereof, dilauryl thiodipropionate, distearyl thiodipropionate, thiodipropionic acid and derivatives thereof (esters, ethers, peptides, lipids, nucleotides, nucleosides and salts) and also sulfoximine compounds (e.g. buthionine sulfoximines, homocysteine sulfoximine, buthionine sulfones, penta-, hexa-, hepta-thionine sulfoximine), also (metal) chelating agents (e.g. γ-hydroxy fatty acids, palmitic acid phytic acid, lactoferrin), β-hydroxy acids (e.g. citric acid, lactic acid, malic acid), humic acid, bile acid, bile extracts, bilirubin, biliverdin, EDTA, EGTA and derivatives thereof, unsaturated fatty acids and derivatives thereof (e.g. linolenic acid, linoleic acid, oleic acid), folic acid and derivatives thereof, ubiquinone and ubiquinol and derivatives thereof, vitamin C and derivatives (e.g. ascorbyl palmitate, magnesium ascorbyl phosphate, ascorbyl acetate), tocopherols and derivatives (e.g. vitamin E acetate), vitamin A and derivatives (e.g. vitamin A palmitate) and also coniferyl benzoate of benzoin resin, rutinic acid and derivatives thereof, α-glycosylrutin, ferulic acid, furfurylidene glucitol, carnosine, butyl hydroxytoluene, butyl hydroxyanisole, nordihydroguaiaretic acid, trihydroxybutyrophenone, uric acid and derivatives thereof, mannose and derivatives thereof, superoxide dismutase, N-[3-(3,5-di-tert-butyl-4-hydroxyphenyl)propionyl]-sulfanilic acid (and salts thereof, for example the disodium salts), zinc and derivatives thereof (e.g. ZnO, ZnSO₄), selenium and derivatives thereof (e.g. selenium methionine), stilbene and derivatives thereof (e.g. stilbene oxide, trans-stilbene oxide) and the derivatives (salts, esters, ethers, sugars, nucleotides, nucleosides, peptides and lipids) of HALS (=“Hindered Amine Light Stabilizers”) compounds may also be mentioned.

The amount of antioxidants present is usually from 0.001 wt.-% to 25 wt.-%, preferably from 0.01 wt.-% to 3 wt.-%, based on the weight of the personal care product.

### Hydrotropic Agents:

To improve the flow behavior of the compositions it is also possible to employ hydrotropic agents, for example ethoxylated or non ethoxylated mono-alcohols, diols or polyols with a low number of C-atoms or their ethers (e.g. ethanol, isopropanol, 1,2-dipropanediol, propylene glycol, glycerin, ethylene glycol, ethylene glycol monoethyl ether, ethylene glycol monobutyl ether, propylene glycol monomethylether, propylene glycol monoethylether, propylene glycol monobutyl ether, diethylene glycol monomethylether; diethylene glycol monoethylether, diethylene glycol monobutyl ether and similar products). The polyols that come into consideration for that purpose have preferably from 2 to 15 carbon atoms and at least two hydroxy groups. The polyols may also contain further functional groups, especially amino groups, and/or may be modified with nitrogen. Typical examples are as follows: glycerol, alkylene glycols, for example ethylene glycol, diethylene glycol, propylene glycol, butylene glycol, hexylene glycol and also polyethylene glycols having an average molecular weight of from 100 to 1000 Daltons; technical oligoglycerol mixtures having an intrinsic degree of condensation of from 1.5 to 10, for example technical diglycerol mixtures having a diglycerol content of from 40 wt.-% to 50 wt.-%; methylol compounds, such as, especially trimethylolethane, trimethylolpropane, trimethylolbutane, pentaerythritol and dipentaerythritol; lower alkyl-glucosides, especially those having from 1 to 8 carbon atoms in the alkyl radical, for example methyl and butyl glucoside; sugar alcohols having from 5 to 12 carbon atoms, for example sorbitol or mannitol; sugars having from 5 to 12 carbon atoms, for example glucose or saccharose; amino sugars, for example glucamine; dialcohol amines, such as diethanolamine or 2-amino-1,3-propanediol.

### Preservatives and Bacteria-Inhibiting Agents:

Suitable preservatives include, for example, methyl-, ethyl-, propyl-, butyl-parabens, benzalkonium chloride, 2-bromo-2-nitro-propane-1,3-diol, dehydroacetic acid, diazolidinyl urea, 2-dichloro-benzyl alcohol, DMDM hydantoin, formaldehyde solution, methyldibromoglutanitrile, phenoxyethanol, sodium hydroxymethylglycinate, imidazolidinyl urea and triclosan, and further substance classes listed in the following reference: K.: F. DePolo—A Short Textbook Of Cosmetology, Chapter 7, Tables 7-2, 7-3, 7-4 and 7-5, pp 210-219.

### Bacteria-Inhibiting Agents:

Typical examples of bacteria-inhibiting agents are preservatives that have a specific action against gram-positive bacteria, such as 2,4,4′-trichloro-2′-hydroxydiphenyl ether (Irgasan® DP 300/Ciba), chlorhexidine (1,6-di(4-chlorophenyl-biguanido)hexane) or TCC (3,4,4′-trichlorocarbanilide). A large number of aromatic substances and ethereal oils also have antimicrobial properties. Typical examples are the active ingredients eugenol, menthol and thymol in clove oil, mint oil and thyme oil. A natural deodorizing agent of interest is the terpene alcohol farnesol (3,7,11-trimethyl-2,6,10-dodecatrien-1-ol), which is present in lime blossom oil. Glycerol monolaurate has also proved to be a bacteriostatic agent.

The amount of the additional bacteria-inhibiting agents present is usually from 0.1 wt-% to 2 wt-%, based on the solid content of the preparations.

### Perfume Oils:

There may be mentioned as perfume oils mixtures of natural and/or synthetic aromatic substances. Natural aromatic substances are, for example, extracts from blossom (lilies, lavender, roses, jasmine, neroli, ylang-ylang), from stems and leaves (geranium, patchouli, petitgrain), from fruit (aniseed, coriander, caraway, juniper), from fruit peel (bergamot, lemons, oranges), from roots (mace, angelica, celery, cardamom, costus, iris, calmus), from wood (pinewood, sandalwood, guaiacum wood, cedarwood, rosewood), from herbs and grasses (tarragon, lemon grass, sage, thyme), from needles and twigs (spruce, pine, scotch pine, mountain pine), from resins and balsams (galbanum, elemi, benzoin, myrrh, olibanum, opoponax). Animal raw materials also come into consideration, for example civet and castoreum. Typical synthetic aromatic substances are, for example, products of the ester, ether, aldehyde, ketone, alcohol or hydrocarbon type. Aromatic substance compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethylmethylphenyl glycinate, allylcyclohexyl propionate, styrallyl propionate and benzyl salicylate. The ethers include, for example, benzyl ethyl ether; the aldehydes include, for example, the linear alkanals having from 8 to 18 hydrocarbon atoms, citral, citronellal, citronellyl oxyacetaldehyde, cyclamen aldehyde, hydroxycitronellal, lilial and bourgeonal; the ketones include, for example, the ionones, isomethylionone and methyl cedryl ketone; the alcohols include, for example, anethol, citronellol, eugenol, isoeugenol, geraniol, linalool, phenyl ethyl alcohol and terpinol; and the hydrocarbons include mainly the terpenes and balsams. It is preferable, however, to use mixtures of various aromatic substances that together produce an attractive scent. Ethereal oils of relatively low volatility, which are chiefly used as aroma components, are also suitable as perfume oils, e.g. sage oil, camomile oil, clove oil, melissa oil, oil of cinnamon leaves, lime blossom oil, juniper berry oil, vetiver oil, olibanum oil, galbanum oil, labolanum oil and lavandin oil. Preference is given to the use of bergamot oil, dihydromyrcenol, lilial, lyral, citronellol, phenyl ethyl alcohol, α-hexyl cinnamaldehyde, geraniol, benzyl acetone, cyclamen aldehyde, linalool, boisambrene forte, ambroxan, indole, hedione, sandelice, lemon oil, tangerine oil, orange oil, allyl amyl glycolate, cyclovertal, lavandin oil, muscatel sage oil, a-damascone, bourbon geranium oil, cyclohexyl salicylate, vertofix coeur, iso-E-Super, Fixolide NP, evernyl, iraldein gamma, phenylacetic acid, geranyl acetate, benzyl acetate, rose oxide, romillat, irotyl and floramat alone or in admixture with one another.

### Colorants:

There may be used as colorants any substances that are suitable and permitted for cosmetic purposes, as compiled, for example, in the publication “Kosmetische Färbemittel” of the Farbstoffkommission der Deutschen Forschungsgemeinschaft, Verlag Chemie, Weinheim, 1984, pages 81 to 106. The colorants are usually used in concentrations of from 0.001 wt.-% to 0.1 wt.-%, based on the total mixture.

### Other Adjuvants:

It is furthermore possible for the personal care composition to contain, as adjuvants, antifoams, such as silicones, structurants, such as maleic acid, solubilizers, such as ethylene glycol, propylene glycol, glycerol or diethylene glycol, opacifiers, such as latex, styrene/PVP or styrene/acrylamide copolymers, complexing agents, such as EDTA, NTA, alaninediacetic acid or phosphonic acids, propellants, such as propane/butane mixtures, N₂O, dimethyl ether, CO₂, N₂ or air, so-called coupler and developer components as oxidation dye precursors, reducing agents, such as thioglycolic acid and derivatives thereof, thiolactic acid, cysteamine, thiomalic acid or mercaptoethanesulfonic acid, or oxidizing agents, such as hydrogen peroxide, potassium bromate or sodium bromate.

There come into consideration as insect repellents, for example, N,N-diethyl-m-toluamide, 1,2-pentanediol or insect repellent 3535; suitable self-tanning agents are, for example, dihydroxyacetone and/or erythrulose or dihydroxy acetone and/or dihydroxy acetone precursors as described in WO 01/85124 and/or erythrulose.

### Ultraviolet Light Absorber:

Ultraviolet Light Absorbers (UV absorbers) are employed in cosmetics to protect the product from chemical or physical deterioration induced by ultraviolet light. Sunscreen agents are OTC drug ingredients, which protect the skin from ultraviolet light. UV absorbers, like sunscreen agents, have the ability to convert incident ultraviolet radiation into less damaging infrared radiation (heat).

Suitable UV Absorbers are, for Example:

Acetaminosalol, allantoin PABA, Benzalphthalide, benzophenone, Benzophenone-1, Benzophenone-2, Benzophenone-3, Benzophenone-4, Benzophenone-5, Benzophenone-6, Benzophenone-7, Benzophenone-8, Benzophenone-9, Benzophenone-10, Benzophenone-11, Benzophenone-12, benzotriazolyl dodecyl p-cresol, 3-benzylidene camphor, benzylidenecamphor hydrolyzed collagen sulfonamide, benzylidene camphor sulfonic acid, benzyl salicylate, bis-ethylhexyloxyphenol methoxyphenyl triazine, bornelone, bumetrizole, butyl methoxydibenzoylmethane, Butyl PABA, Callophyllum Inophyllum seed oil, Camellia Sinensis leaf extract, carotenoids, Ceria/Silica, Ceria/Silica talc, Cinoxate, DEA-methoxycinnamate, dibenzoxazoyl naphthalene, di-t-butyl hydroxybenzylidene camphor, diethylhexyl butamido triazone, diethylhexyl 2,6-naphthalate, digalloyl trioleate, diisopropyl methyl cinnamate, 1-(3,4-dimethoxyphenyl)-4,4-dimethyl-1,3-pentanediene, dimethyl PABA, ethyl cetearyidimonium tosylate, dimorpholinopyridazinone, diphenyl carbomethoxy acetoxy naphthopyran, disodium bisethylphenyl triaminotriazine stilbenedisulfonate, disodium distyrylbiphenyl disulfonate, disodium phenyl dibenzimidazole tetrasulfonate, Drometrizole, Drometrizole Trisiloxane, Esculin, ethyl dihydroxypropyl PABA, ethyl diisopropylcinnamate, ethylhexyl dimethoxybenzylidene dioxoimidazolidine propionate, ethylhexyl dimethyl PABA, ethylhexyl Ferulate, ethylhexyl methoxycinnamate, ethylhexyl salicylate, ethylhexyl triazone, ethyl methoxycinnamate, ethyl PABA, ethyl urocanate, Etocrylene, Ferulic Acid, 4-(2-β-glucopyranosiloxy) propoxy-2-hydroxybenzophenone, glyceryl ethylhexanoate dimethoxycinnamate, glyceryl PABA, glycol salicylate, hexanediol salicylate, homosalate, hydrolyzed lupine protein, isoamyl p-methoxycinnamate, isopentyl trimethoxycinnamate trisiloxane, isopropylbenzyl salicylate, isopropyl dibenzoylmethane, isopropyl methoxycinnamate, menthyl anthranilate, menthyl salicylate, 4-methylbenzylidene camphor, methylene bis-benzotriazolyl tetramethylbutylphenol, octocrylene, octrizole, PABA, PEG-25 PABA, pentyl dimethyl PABA, phenylbenzimidazole sulfonic acid, Pinus Pinaster bark extract, polyacrylamidomethyl benzylidene camphor, Polysilicone-15, potassium methoxycinnamate, potassium phenylbenzimidazole sulfonate, red petrolatum, sodium benzotriazolyl butylphenol sulfonate, sodium isoferulate, sodium phenylbenzimidazole sulfonate, sodium urocanate, Spirulina Platensis Powder, TEA-phenylbenzimidazole sulfonate, TEA-salicylate, terephthalylidene dicamphor sulfonic acid, tetrabutyl phenyl hydroxybenzoate, titanium dioxide, tocotrienols, TriPABA Panthenol, urocanic acid, VA/crotonates/methacryloxybenzophenone-1 copolymer and Vitis Vinifera (grape) seed extract.

Sunscreen compositions may contain polymeric beads or hollow spheres as SPF enhancers. The combination of UV-absorbers as described above, with SPF enhancers, such as non-active ingredients like styrene/acrylate copolymers, silica beads, spheroidal magnesium silicates, spherical polyamide powders such as n-lactam polymers (Orgasol® range, Elf Atochem) cross linked polymethyl methacrylates (PMMA; Micopearl M305 Seppic), can enhance the UV protection of the sun products. Holosphere additives (Sunspheres® ISP, Silica Shells Kobo.) deflect radiation, and the effective path length of a photon is therefore increased (see EP0893119). Some beads provide a soft feel during spreading. Moreover, the optical activity of such beads, e.g. Micropearl M305, can modulate skin shine by eliminating reflection phenomena and indirectly may scatter UV light. When formulated in O/W sunscreen emulsions, preferably the amount of such SPF enhancers should represent 1 wt.-% to 10 wt.-% of the total amount of the personal care composition.

A typical O/W-based antimicrobial personal care composition comprises:
0.05 to 10 wt.-% of at least one metal oxide nanoparticle coated with phosphonates of formula (I),
0.5-10 wt.-% of other suitable non-antimicrobial polymers or copolymers,
2-25 wt.-% of at least one oil-component,
0-25 wt.-% of at least one other adjuvant and/or additive,
   water up to 100 wt.-%.

A typical oil-based antimicrobial personal care composition comprises:
0.05 to 10 wt.-% of at least one metal oxide nanoparticle coated with phosphonates of formula (I)
0.5-10 wt.-% of other suitable non-antimicrobial polymers or copolymers,
50-99 wt.-% of at least one oil-component,
0-25 wt.-% of at least one other adjuvant and/or additive.

An antimicrobial soap has, for example, the following composition:
0.05 to 10 wt.-% of at least one metal oxide nanoparticle coated with phosphonates of formula (I),
0.5-10 wt.-% of other suitable non-antimicrobial polymers or copolymers,
0.3 to 1% wt.-% of titanium dioxide,
1 to 10% wt.-% of stearic acid,
   to 100 wt.-% of soap base, for example the sodium salts of tallow fatty and coconut fatty acid or glycerols.

An antimicrobial shampoo has, for example, the following composition:
0.05 to 10 wt.-% of at least one metal oxide nanoparticle coated with phosphonates of formula (I),
0.5-10 wt.-% of other suitable non-antimicrobial polymers or copolymers,
12.0% wt.-% of sodium laureth-2-sulfate,
4.0% wt.-% of cocamidopropylbetaine,
3.0% wt.-% of NaCl and
   water to 100 wt.-%.

An antimicrobial deodorant has, for example, the following composition:
0.05 to 10 wt.-% of at least one metal oxide nanoparticle coated with phosphonates of formula (I)
0.5-10 wt.-% of other suitable non-antimicrobial polymers or copolymers,
60 wt.-% of ethanol,
0.3 wt.-% of perfume oil and
   water to 100 wt.-%.

The invention relates also to an oral care composition containing from 0.01 to 15 wt.-%, based on the total weight of the composition, of at least one metal oxide nanoparticle coated with phosphonates of formula (I) and orally tolerable adjuvants.

The oral hygiene composition may comprise an additional antibacterial enhancing agent, for example an anionic polymeric polycarboxylate, a dehydrated polyphosphate salt, a compound which provides a source of fluoride ions, a polishing material, including siliceous material or sodium bicarbonate, an orally acceptable vehicle, including a water-phase with humectants, thickeners, surface-active agents and a flavoring or sweetening material.

An oral antimicrobial composition has, for example, the following composition:

10 wt.-% sorbitol,
10 wt.-% glycerol,
15 wt.-% ethanol,
15 wt.-propylene glycol,
0.5 wt.-% sodium lauryl sulfate,
0.25 wt.-% sodium methylcocyl taurate,
0.25 wt.-% polyoxypropylene/polyoxyethylene block copolymer,
0.10% wt.-% peppermint flavoring,
0.1 to 0.5 wt.-% of a biomimic antimicrobial polymer, and
48.6 wt.-% water.

The oral composition according to the invention may be, for example, in the form of a gel, a paste, a cream or an aqueous preparation (mouthwash).

The oral composition according to the invention may also comprise compounds that release fluoride ions which are effective against the formation of caries, for example inorganic fluoride salts, e.g. sodium, potassium, ammonium or calcium fluoride, or organic fluoride salts, e.g. amine fluorides, which are known under the trade name Olafluor.

The metal oxide nanoparticles coated with phosphonates of formula (I) are also useful in washing and cleaning formulations, e.g. in liquid or powder washing agents or softeners, and household and general-purpose cleaners for cleaning and disinfecting hard surfaces.

A cleaning preparation has, for example the following composition:
0.01 to 5 wt.-% of at least one metal oxide nanoparticle coated with phosphonates of formula (I),
3.0 wt.-% octyl alcohol 4EO,
1.3 wt.-% fatty alcohol C₈-C₁₀polyglucoside,
3.0 wt.-% isopropanol, and
   water ad 100 wt.-%.

In addition to preserving cosmetic and household products, the preservation of technical products, the provision of technical products with antimicrobial properties and use as a biocide in technical processes are also possible, for example in paper treatment, especially in paper treatment liquors, printing thickeners of starch or cellulose derivatives, surface-coatings and paints. The biomimic antimicrobial polymers are also suitable for the antimicrobial treatment of leather, the preserving of leather and the provision of leather with antimicrobial properties.

The metal oxide nanoparticles coated with phosphonates of formula (I) are also suitable for the protection of cosmetic products and household products from microbial damage.

The metal oxide nanoparticles coated with phosphonates of formula (I) are also suitable advantageously for applications that require long-term hygienic activity on the surface, e.g., medical devices, hand rails, door handles, etc. For that purpose the inventive nanoparticles are coated onto a surface and/or incorporated into the material, which should be protected. Such materials are used for example in hospitals, households, public institutions, ventilation systems, air cleaning and air conditioning systems and waste disposal systems. Plastic articles exposed to outdoor weathering that may have incorporated therein metal oxide nanoparticles coated with phosphonates of formula (I) of the present invention are for example waste containers, swimming pool equipment, outdoor swing set equipment, slides and the like, and stadium seats.

In general the plastic resins polymer substrates may be selected from:

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:

a) radical polymerisation (normally under high pressure and at elevated temperature).
b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.

5. Polystyrene, poly(p-methylstyrene), poly(α-methylstyrene).

6. Aromatic homopolymers and copolymers derived from vinyl aromatic monomers including styrene, a-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bisglycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides, polyetherimids, polyesterimids, polyhydantoins and polybenzimidazoles.

18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block copolyether esters derived from hydroxyl-terminated polyethers; and also polyesters modified with polycarbonates or MBS.

19. Polycarbonates and polyester carbonates.

20. Polyketones.

21. Polysulfones, polyether sulfones and polyether ketones.

22. Crosslinked polymers derived from aldehydes on the one hand and phenols, ureas and melamines on the other hand, such as phenol/formaldehyde resins, urea/formaldehyde resins and melamine/formaldehyde resins.

23. Drying and non-drying alkyd resins.

24. Unsaturated polyester resins derived from copolyesters of saturated and unsaturated dicarboxylic acids with polyhydric alcohols and vinyl compounds as crosslinking agents, and also halogen-containing modifications thereof of low flammability.

25. Crosslinkable acrylic resins derived from substituted acrylates, for example epoxy acrylates, urethane acrylates or polyester acrylates.

26. Alkyd resins, polyester resins and acrylate resins crosslinked with melamine resins, urea resins, isocyanates, isocyanurates, polyisocyanates or epoxy resins.

27. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.

28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

29. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

30. Naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.

31. Aqueous emulsions of natural or synthetic rubber, e.g. natural latex or latices of carboxylated styrene/butadiene copolymers.

32. Polysiloxanes such as the soft, hydrophilic polysiloxanes described, for example, in U.S. Pat. No. 4,259,467; and the hard polyorganosiloxanes described, for example, in U.S. Pat. No. 4,355,147.

33. Polyketimines in combination with unsaturated acrylic polyacetoacetate resins or with unsaturated acrylic resins. The unsaturated acrylic resins include the urethane acrylates, polyether acrylates, vinyl or acryl copolymers with pendant unsaturated groups and the acrylated melamines. The polyketimines are prepared from polyamines and ketones in the presence of an acid catalyst.

34. Radiation curable compositions containing ethylenically unsaturated monomers or oligomers and a polyunsaturated aliphatic oligomer.

35. Epoxymelamine resins such as light-stable epoxy resins crosslinked by an epoxy functional coetherified high solids melamine resin such as LSE-4103 (Monsanto).

Preferably, the plastic resin is selected from the group consisting of polyethylene (for example LDPE, HDPE or MDPE), polypropylene, acrylonitrile-butadiene-styrene copolymer (ABS), styrene-acrylonitrile copolymer (SAN), polystyrene (PS), polymethyl methacrylate (PMMA), polyethylene terephthalate (PET), polyamide, polyvinyl chloride (PVC), polymer latex, polyurethane (PUR), thermoplastic polyurethane (TPU), urea formaldehyde resin (UF) and unsaturated polyester (UP).

The instant invention pertains also to an antimicrobial polymer composition comprising

A) a polymer substrate, and
B) an effective antimicrobial amount of at least one antimicrobial agent as described above.

The effective antimicrobial amount of component (B) is for example 0.005 to 10%, based on the weight of component (A).

In addition to the metal oxide nanoparticles coated with specific phosphonates, optional further additives may be added to the plastic resin, e.g. the polyolefin, individually or mixed with one another. If desired, the individual components of an additive mixture can be mixed with one another in the melt (melt blending) before incorporation into the plastic material.

The incorporation of the metal oxide nanoparticles coated with specific phosphonates and optional further additives into the plastic material is carried out by known methods such as dry mixing in the form of a powder, or wet mixing in the form of solutions or suspensions. The metal oxide nanoparticles coated with specific phosphonates and optional further additives may be incorporated, for example, before or after molding or also by applying the dissolved or dispersed stabilizer mixture to the plastic material, with or without subsequent evaporation of the solvent. The metal oxide nanoparticles coated with specific phosphonates and optional further additives can also be added to the plastic material in the form of a masterbatch which contains these components in a concentration of, for example, about 2.5% to about 70% by weight; in such operations, the polymer can be used in the form of powder, granules, solutions, suspensions or in the form of latices.

If added to a plastic resin in the form of a masterbatch or concentrate, the metal oxide nanoparticles coated with specific phosphonates is added via carriers such as LDPE, HDPE, MDPE, PP, ABS, SAN, PS, acrylates, PMMA, polyamide, polyesters, PVC, latex, styrene, polyol, TPU, unsaturated esters, urea, paraformaldehyde, water emulsion, etc. The total concentration of the metal oxide nanoparticles coated with specific phosphonates in the carriers is from about 2.5% to about 70% by weight based on the weight of the carrier.

The metal oxide nanoparticles coated with specific phosphonates and optional further additives can also be added before, during or after polymerization or crosslinking.

The metal oxide nanoparticles coated with specific phosphonates and optional further additives can be incorporated into the plastic material in pure form or encapsulated in waxes, oils or polymers.

The metal oxide nanoparticles coated with specific phosphonates and optional further additives can also be sprayed onto the plastic material. They are able to dilute other additives (for example the conventional additives indicated above) or monomers or their melts so that they can be sprayed also together with these additives onto the plastic material. Addition by spraying during the deactivation of the polymerization catalysts is particularly advantageous, it being possible to carry out spraying using, for example, the steam used for deactivation.

In the case of spherically polymerized polyolefins it may, for example, be advantageous to apply the metal oxide nanoparticles coated with specific phosphonates and optionally together with other additives, by spraying.

The metal oxide nanoparticles coated with specific phosphonates and/or the specific phosphonates are suitable as flame retarder. The above mentioned metal oxide nanoparticles coated with specific phosphonates and/or the specific phosphonates can also be used in combination with commonly known flame retarder compounds.

For the use as flame retarder, the metal oxide nanoparticles coated with specific phosphonates and/or preferably the specific phosphonates are used in a concentration of from 1 to 30% by weight, for example from 3 to 20% by weight, preferably from 3 to 15% by weight, based on the polymer material.

The same polymer material as describes above for the use as antimicrobials can be used. The incorporation of the metal oxide nanoparticles coated with specific phosphonates is identical as well.

The following examples describe certain embodiments of this invention, but the invention is not limited thereto. It should be understood that numerous changes to the disclosed embodiments could be made in accordance with the disclosure herein without departing from the spirit or scope of the invention. These examples are therefore not meant to limit the scope of the invention. Rather, the scope of the invention is to be determined only by the appended claims and their equivalents. In these examples all parts given are by weight and the temperatures are given in degree Celsius unless otherwise indicated.

### EXAMPLES

### Example 1

### Preparation of Compound A

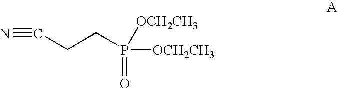

3-Chloroproprionitrile (172.8 g, 1.93 mols) and 336 ml of triethyl phosphite are mixed together and slowly heated up to 160° C. whereby the sideproducts are continuously distilled off. When the distillation has ceased, usually after 24 h, the residue is distilled at 95° C. and 0.2 mbar. Compound A is obtained in a yield of 62%.

¹H-NMR (300 MHz, CDCl₃, ppm): 1.28 t, 6H, 1.96-2.07 m, 2H, 2.52-2.62 m, 2H; 4.0-4.13 m, 4H

³¹P-NMR (121 MHz, CDCl₃, ppm): 26.65

### Example 2

### Preparation of Compound B

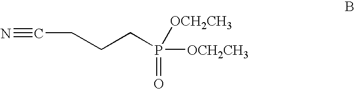

4-Chlorobutyronitrile (200.2 g, 1.93 mols) and 336 ml of triethyl phosphite are mixed together and slowly heated up to 160° C. whereby the sideproducts are continuously distilled off. When the distillation has ceased, usually after 24 h, the residue is distilled at >120° C. and 0.2 mbar. Compound B is obtained in a yield of 78%.

¹H-NMR (300 MHz, CDCl₃, ppm): 1.19 t, 6H, 1.68-1.91 m, 4H, 2.38 t, 2H, 3.90-4.02 m, 4H

³¹P-NMR (121 MHz, CDCl₃, ppm): 29.6

### Example 3

### Preparation of Compound C

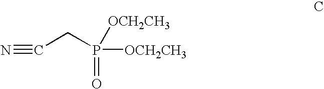

Chloroacetonitrile (145.7 g, 1.93 mols) and 336 ml of triethyl phosphite are mixed together and slowly heated up to 160° C. whereby the sideproducts are continuously distilled off. When the distillation has ceased, usually after 24 h, the residue is distilled at 120° C. and 0.3 mbar. Compound C is obtained in a yield of 63%.

¹H-NMR (300 MHz, CDCl₃, ppm): 1.28 t, 6H, 2.80 d, 2H, 4.07-4.17 m, 4H

³¹P-NMR (121 MHz, CDCl₃, ppm): 15.39

### Example 4

### Preparation of Compound D

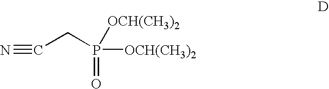

Chloroacetonitrile (145.7 g, 1.93 mols) and 380 ml of triisopropyl phosphite are mixed together and slowly heated up to 160° C. whereby the sideproducts are continuously distilled off. When the distillation has ceased, usually after 24 h, the residue is distilled at >120° C. and 0.2 mbar. Compound B is obtained in a yield of 78%.

¹H-NMR (300 MHz, CDCl₃, ppm): 1.29-1.33 m, 12H, 2.72 d, 1H, 2.80 d, 1H; 4.67-4.79 m, 2H.

³¹P-NMR (121 MHz, CDCl₃, ppm): 13.10.

### Example 5

### Preparation of Compound E

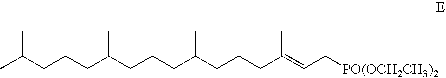

In a first step, phythol (25 ml, 68.2 mmol) is dissolved in 50 ml dry diethyl ether at 0° C. To this mixture are added 2.2 ml (22.7 mmol) phosphorous tribromide under vigorous stirring. The resulting solution is stirred over night at room temperature and subsequently extracted with sodium hydrogen carbonate and brine. The organic phases are combined, dried over sodium sulfate and finally distilled off to give pure phythyl bromide as a colorless residue (24.7 g, 86%).

The above bromide (24.7 g) is dissolved in dry toluene (120 ml) and triethyl phosphite (20 ml) and heated to 60° C. for 48 h. After cooling to room temperature the mixture is taken up in ethyl acetate and successively extracted with water and brine. Removal of the solvent leaves a residue which is purified by column chromatography. 25.4 g of pure phythyl phosphate (compound E) is obtained in a yield of 89%.

¹H-NMR (300 MHz, CDCl₃, ppm): 0.88 t, 12H, 1.01-1.58 m, 25H, 1.62-1.75 m, 3H; 1.97-2.09 m, 2H, 2.54 dd, 2H, 4.03-4.15 m, 4H; 5.15-5.19 m, 1H

³¹P-NMR (121 MHz, CDCl₃, ppm): 29.48

### Example 6

### Preparation of Compound F

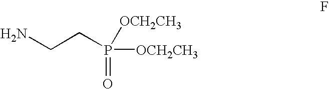

0.8 kg of compound C of Example 3 is dissolved in 8.0 l ethanol, containing 0.80 kg of liquid ammonia in a pressure vessel, which is charged with 160 g Raney-Nickel, and then heated to 80° C. at a hydrogen pressure of 120 bar until hydrogen consumption ceases (ca. 16 h). After cooling down, the catalyst is filtered off over Celite® (World Minerals Inc.) and washed with ethanol. The ethanol is distilled off at reduced pressure and the resulting residue distilled via a short-path distillation apparatus at about 11° C. and 0.18 mbar to give Compound F in a yield of 90%.

¹H-NMR (300 MHz, CDCl₃, ppm): 1.07 t, 6H, 1.42 s broad, 2H, 1.61-1.72 dt, 2H, 2.68-2.77 dt, 2H, 3.77-3.90 m, 4H.

³¹P-NMR (121 MHz, CDCl₃, ppm): 30.97

### Example 7

### Preparation of Compound G

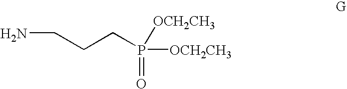

According example 6, compound G is obtained from compound A of example 1 in an analoguos fashion via a short-path distillation apparatus at about 115° C. and 0.18 mbar in a yield of 90%.

¹H-NMR (300 MHz, CDCl₃, ppm): 1.08 t, 6H, 1.50-1.60 m, 6H, 2.52 t, 2H, 3.77-3.90 m, 4H.

³¹P-NMR (121 MHz, CDCl₃, ppm): 32.76.

### Example 8

### Preparation of Compound H

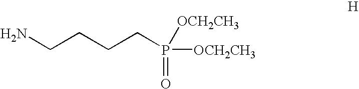

According example 6, compound H is obtained from compound B of example 2 in an analoguos fashion via a short-path distillation apparatus at about 115° C. and 0.18 mbar in a yield of 90%.

¹H-NMR (300 MHz, CDCl₃, ppm): 1.13 s broad, 2H, 1.20 t, 6H, 1.39-1.67 m, 6H, 2.58 t, 2H, 3.91-4.02 m, 4H.

³¹P-NMR (121 MHz, CDCl₃, ppm): 32.71.

### Example 9

### Preparation of Compound I

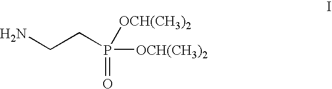

According example 6, compound I is obtained from compound D of example 4 in an analoguos fashion via a short-path distillation apparatus at about 130° C. and 0.10 mbar in a yield of 87%.

¹H-NMR (300 MHz, CDCl₃, ppm): 1.25-1.35 m, 12H, 1.93-1.99 m, 2H, 2.87-2.91 m, 2H, 3.29-3.32 m, 2H, 3.35 broad, 2H.

³¹P-NMR (121 MHz, CDCl₃, ppm): 29.26.

### Example 10

### Preparation of Compound J

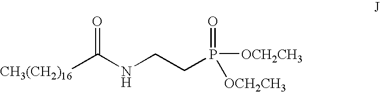

100 ml dry dichloromethane is cooled down to 0° C. under an atmosphere of nitrogen and charged with 7.4 ml dry triethyl amine and 10 g of compound F of Example 6. To this mixture are subsequently added 15.9 g of freshly distilled stearenic acid chloride (CH₃(CH₂)₁₆COOCl). The mixture is stirred for 24 h and during which time it slowly warms up to room temperature. The dichloromethane solution is then successively washed with 1 N hydrochloric acid, satured hydrogen carbonate solution and brine. After drying the organic phase over sodium sulfate the dichloromethane is removed on an aspirator and the oily residue purified over a short column of silica gel. Compound J is obtained in a yield of 90%.

¹H-NMR (300 MHz, CDCl₃, ppm): 0.88 t, 3H, 1.23-1.27 m, 28H, 1.33 t, 6H, 1.61 broad t, 2H, 1.96 dt, 2H, 2.15 t, 2H, 3.49-3.58 m, 2H; 4.04-4.15 m, 4H, 6.35 broads, 1H

³¹P-NMR (121 MHz, CDCl₃, ppm): 30.79

### Example 11

### Preparation of Compound K

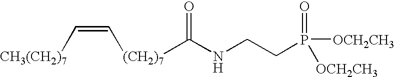

According example 10, compound K is obtained from compound F of example 6 in an analoguos fashion with freshly distilled oleic acid chloride (CH₃(CH₂)₇CH═CH(CH₂)₇COOCl). Compound K is obtained in a yield of 81%.

¹H-NMR (300 MHz, CDCl₃, ppm): 0.81, t, 3H, 1.18-1.29 m, 26H, 1.52-1.57 m, 2H; 1.84-1.95 m, 6H, 2.09 t, 2H, 3.47 dq, 2H; 3.97-4.09 m, 4H, 5.24-5.27 m, 2H, 6.25 broad, 1H.

³¹P-NMR (121 MHz, CDCl₃, ppm): 30.75.

### Example 12

### Preparation of Compound L

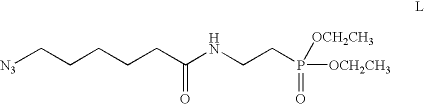

According example 10, compound L is obtained from compound F of example 6 in an analoguos fashion with freshly distilled 6-azido hexanoic acid. Compound L is obtained in a yield of 87%.

¹H-NMR (300 MHz, CDCl₃, ppm): 1.18-1.32 m, 8H, 1.43-1.58 m, 4H, 1.85 dt, 2H; 2.05 t, 2H, 3.13 t, 2H, 3.31-3.44 dq, 2H, 3.90-4.04 m, 4H, 6.6 broad s, 1H

³¹P-NMR (121 MHz, CDCl₃, ppm): 30.24

### Example 13

### Preparation of Compound M

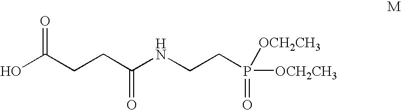

Succinic acid anhydride (2.0 g) is dissolved at room temperature in 20 ml of dry tetrahydrofuran. To this mixture are given 3.62 g of compound F of Example 6 and the resulting mixture warmed up to 60° C. for 3 h and then stirred for 12 h at room temperature. After removal of the solvent under reduced pressure, compound M is obtained in a yield of 98%.

¹H-NMR (300 MHz, CDCl₃, ppm): 1.25 t, 6H, 1.95 dt, 2H, 2.42 t, 2H, 2.57 t, 2H, 3.26-3.49 m, 2H, 3.96-4.08 m, 4H, 7.14 broad t, 1H

³¹P-NMR (121 MHz, CDCl₃, ppm): 30.69

### Example 14

### Preparation of Compound N

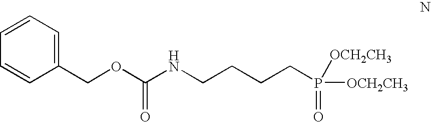

In a mixture of dioxane (75 ml) and water (100 ml) are successively dissolved 6.0 g sodium hydrogen carbonate as base and 10.0 g of compound H of example 8. The mixture is cooled to 0° C. and 10.0 ml of benzyloxy carbonyl chloride are dropped to the solution with vigorous stirring. The reaction mixture is slowly warmed up during 12 h to room temperature. The reaction mixture is then diluted with ethyl acetate and successively extracted with 1 N hydrochloric acid, satured sodium chloride solution and brine and dried over sodium sulfate. A colorless syrup is obtained after removal of the organic solvent. The syrup is passed over a short silica gel column. Compound N is obtained in a yield of 86%.

¹H-NMR (300 MHz, CDCl₃, ppm): 1.23 t, 6H, 1.46-1.70 m, 6H, 3.09 broad q, 2H, 3.92-4.05 m, 4H, 5.00 s, 2H, 5.37 broad t, 1H, 7.25 m, 5H

³¹P-NMR (121 MHz, CDCl₃, ppm): 30.62

### Example 15

### Preparation of Compound O

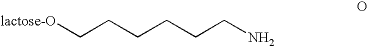

In a first step, per-O-acetylated lactose (2.00 g) and 6-N-benzyloxy-carbonyl aminohexanol (3.60 g) are dissolved in 50 ml dry dichloromethane at 0° C. To this mixture is dropped borontrifluoride etherate complex (5.5 ml) and the mixture stirred for 8 h. To complete the reaction, additional catalyst trimethylsilyl-trifluoromethane sulfonate (0.40 ml) is added and the mixture stirred for an additional 24 h at room temperature. Thereafter, the mixture is filtered, the organic solvent evaporated and the residue diluted in ethyl acetate, which is successively extracted with satured sodium hydrogen carbonate and brine. After drying the organic phase over sodium sulfate, the solvent is evaporated completely and the residue taken up in methanol (20 ml) containing 1% sodium methanolate (w/w) and stirred for 8 h at room temperature. The mixture is then neutralized with acidic ion exchange resin (Dowex H+). The methanol is evaporated and the residual syrup passed over a silica gel column to give the completely de-acetylated-N-benzyloxy-protected intermediate (1.09 g) in 65% yield. This intermediate is dissolved in methanol (70 ml) containing 0.25 g of Pd on carbon (10% w/w) and hydrogenated under atmospheric pressure until disappearance of the starting material. Thereafter the catalyst is filtered off and the solvent is evaporated. Compound O is obtained in a yield of 99%.

¹H-NMR (300 MHz, CDCl₃, ppm): 1.31-1.45 m, 4H, 1.52 quintett, 2H, 1.65 quintett, 2H; 2.75 t, 2H, 3.22-3.92 m, 13H, 4.27-4.39 m, 2H, 4.77 d, 1H

### Example 16

### Preparation of Compound P

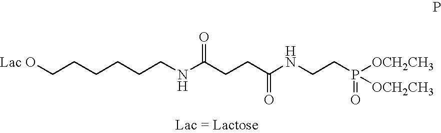

3.8 g of compound M of Example 13 are dissolved at 0° C. in 40 ml dry dimethyl formamide and treated with (benzotriazol-1-yloxy)-tris-(dimethylamino)-phosphonium-hexafluorophosphate (5.97 g) and di-isopropyl-ethylamine (3.2 ml). To this mixture are added a solution of the amine of formula 0 (5.40 g) in dry dimethyl formamide (20 ml) and the resulting reaction mixture is stirred until all the amine of formula 0 is consumed according to a thin layer analysis. The solvent is removed subsequently and the residue passed over a short silica gel column. Compound P is obtained in a yield of 70%.

¹H-NMR (300 MHz, CDCl₃, ppm): 1.31-1.45 m, 10H, 1.51 quintett, 2H, 1.63 quintett, 2H; 2.09 dt, 2H, 2.47 s, 4H, 3.16 q, 2H, 3.34-3.92 m, 15H; 4.05-4.18 m, 4H, 4.27-4.39 m, 2H, 4.76 d, 1H, 7.87 broad d, 1H, 8.00 broad, 1H

³¹P-NMR (121 MHz, CDCl₃, ppm): 30.48

### Example 17

### Coating Titanium Dioxide with the Phosphonate Compounds

6.5 g of compound E of Example 5 are dissolved in dry toluene (400 ml). Titanium dioxide P₂₅ (Ø ca. 21 nm, available from DEGUSSA) is suspended in that solution and the resulting slurry is refluxed for 24 h. The mixture is then cooled down and centrifuged at 4000 rpm for 15 minutes at 4° C. The white precipitate is recovered, resuspended in 200 ml toluene and centrifugated again. This procedure is repeated until no monomeric phosphonate can be detected in the supernatant by thin layer chromatography any more. The purified white precipitate is subsequently dried at room temperature on high vacuum (0.2 mbar) to a constant weight. 19.0 g of coated titanium nanoparticles are obtained.

All the phosphonates of the above mentioned Examples 1-16 can be linked to the metal oxide nanoparticles as described in Example 17.

The amount of coated phosphonate determined according to the various analytical methods is compiled in table 1. According to this protocol all phosphonates (compare table 1) are covalently attached to titanium dioxide particles.

TABLE 1
Amount (μmol/g) of phosphonates I
linked to titanium nanoparticle P₂₅.

| | IR (μmol/g) | P (μmol/g) | C (μmol/g) |
|---|---|---|---|
| TiO₂ coated with compound E | 122 | 148 | 112 |
| TiO₂ coated with compound K | 185 | 92 | 189 |
| TiO₂ coated with compound J | 143 | 89 | 90 |
| TiO₂ coated with compound P | 154 | — | — |
| TiO₂ coated with compound L | 83 | 230 | 150 |
| TiO₂ coated with compound A | — | 135 | 173 |
| TiO₂ coated with compound M | 9 | — | — |
| TiO₂ coated with compound N | 82 | — | — |

### Application Examples

The titanium dioxide particles coated with the appropriate phosphonates were subsequently assayed according the European Standard Assay method EN 1040 against two representative microbes:

S. aureaus (ATCC 6538) and
E. coli (ATCC 10536).

Both microbes were incubated with the coated nanoparticles together with their corresponding free phosphonates within the same apparent concentrations for 5 and 30 minutes, respectively. The bioassay data are listed in table 2.

The data are given in a logarithmic scale which means that the number 5 indicates an increase of activity by a factor of 100000.

TABLE 2
Bioassay data of phosphonate coated titanium dioxide P₂₅.

| | S. aureus | S. aureus | E. coli | E. coli |
|---|---|---|---|---|
| | 5 min | 30 min | 5 min | 30 min |
| TiO₂ coated with | <1 | 1.5 | <1 | >4 |
| compound A | | | | |
| Compound A | <1 | <1 | <1 | <1 |
| TiO₂ coated with | <1 | <1 | <1 | 2.2 |
| compound J | | | | |
| Compound J | <1 | <1 | <1 | <1 |
| TiO₂ coated with | <1 | 1 | 1.8 | >5 |
| compound K | | | | |
| Compound K | <1 | <1 | <1 | <1 |
| TiO₂ coated with | <1 | <1 | <1 | <1 |
| compound P | | | | |
| Compound P | <1 | <1 | <1 | <1 |
| TiO₂ coated with | 1.9 | 4.4 | 2.3 | >5 |
| compound E | | | | |
| Compound E | <1 | <1 | <1 | <1 |
| TiO₂ coated with | <1 | <1 | 1.2 | >5 |
| compound M | | | | |
| Compound M | <1 | <1 | <1 | <1 |
| TiO₂ coated with | <1 | <1 | <1 | 3.9 |
| compound N | | | | |
| Compound N | <1 | <1 | <1 | <1 |
| TiO₂ coated with | <1 | <1 | <1 | 3.2 |
| compound L | | | | |
| Compound L | <1 | <1 | <1 | <1 |

It can be seen that none of the free phosphonates is active at all. However, unexpected high antimicrobial activities of the coated nanoparticles are obtained after 30 minutes (10000 to 100000 times higher than the free phosphonates). In addition the coated nanoparticle of Example 17 shows activities against both microbes even at a contact time of only 5 minutes.

Uncoated titanium nanoparticles P₂₅ did not show any effect even after prolonged incubations.

1. Metal oxide nanoparticles coated with phosphonates of formula (I) 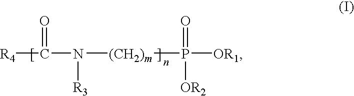
wherein
R₁ and R₂ are independently from each other hydrogen or linear C₁-C₆alkyl or branched C₃-C₆alkyl,
R₃ is hydrogen or C₁-C₄alkyl,
R₄ is linear or branched C₁-C₃₂alkyl, which can be substituted by one or more substituent chosen from the group consisting of halogen, nitrile, azido, COOR₅, NR₆R₇, CONHR₈ and OR₉,
wherein R₅, R₆, R₇, R₈ and R₉ are independently from each other hydrogen, linear or branched C₁-C₃₂alkyl, linear or branched C₂-C₃₂alkenyl, phenyl or C₁-C₄alkylene-phenyl,
linear or branched C₂-C₃₂alkenyl, which can be substituted by one or more substituent chosen from the group consisting of halogen, nitrile, azido, COOR₅, NR₆R₇, CONHR₈ and OR₉,
wherein R₅, R₆, R₇, R₈ and R₉ have the same meanings as defined above, or R₄ is a moiety of formula (a) 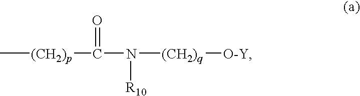
wherein
R₁₀ is hydrogen or C₁-C₄alkyl,
Y is an α- or β-hexo-furanoside or pyranoside, or a disaccharide,
p is an integer from 1 to 8,
q is an integer from 1 to 16,
n is 0 or 1 and
m is an integer from 1 to 8.

2. Metal oxide nanoparticles according to claim 1, wherein the phosphonates of formula (I) are bound to the metal oxide via a covalent bond.

3. Metal oxide nanoparticles according to claim 2
wherein
R₁ and R₂ are independently from each other hydrogen or linear C₁-C₄alkyl or branched C₃-C₆alkyl,
R₃ is hydrogen or CH₃,
R₄ is linear or branched C₁-C₂₆alkyl, which can be substituted by one or more substituent chosen from the group consisting of halogen, nitrile, azido, COOR₅, NR₆R₇, CONHR₈ and OR₉,
wherein R₅, R₆, R₇, R₈ and R₉ are independently from each other hydrogen, linear or branched C₁-C₂₀alkyl, linear or branched C₂-C₂₀alkenyl, phenyl or C₁-C₄alkylene-phenyl,
linear or branched C₂-C₂₆alkenyl, which can be substituted by one or more substituent chosen from the group consisting of halogen, nitrile, azido, COOR₅, NR₆R₇, CONHR₈ and OR₉,
wherein R₅, R₆, R₇, R₈ and R₉ have the same meanings as defined above, or R₄ is a moiety of formula (a) 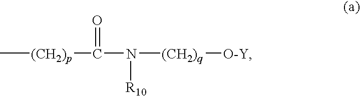
wherein
R₁₀ is hydrogen or C₁-C₂alkyl,
Y is selected from ribose, arabinose, xylose, lyxose, glucose, galactose, mannose, maltose, lactose, 2-N-acetyllactose, cellobiose and derivatives thereof,
p is an integer from 1 to 4,
q is an integer from 2 to 6,
n is 0 or 1 and
m is an integer from 2 to 4.

4. Metal oxide nanoparticles according to claim 3,
wherein
R₁ and R₂ are independently from each other hydrogen or linear C₁-C₂alkyl or branched C₃-C₆alkyl,
R₃ is hydrogen,
R₄ is linear or branched C₁-C₂₂alkyl, which can be substituted by one or more substituent chosen from the group consisting of Cl, F, Br, nitrile, azido, COOR₅, NR₆R₇, CONHR₈ and OR₉,
wherein R₅, R₆, R₇, R₈ and R₉ are independently from each other hydrogen, linear or branched C₁-C₁₀alkyl, linear or branched C₂-C₁₀alkenyl, phenyl or C₁-C₂alkylene-phenyl,
linear or branched C₂-C₂₂alkenyl, which can be substituted by one or more substituent chosen from the group consisting of halogen, nitrile, azido, COOR₅, NR₆R₇, CONHR₈ and OR₉,
wherein R₅, R₆, R₇, R₈ and R₉ have the same meanings as defined above, or R₄ is a moiety of formula (a).

5. Metal oxide nanoparticles according to claim 2,
wherein the metal oxide particles are oxides of titanium, zirconium, silicon, aluminium or tin.

6. Metal oxide nanoparticles according to claim 5 wherein the metal oxide particles are oxides of titanium or zirconium.

7. Metal oxide nanoparticles according to claim 5 wherein the metal oxide particles are oxides of titanium.

8. Metal oxide nanoparticles according to claim 2 wherein the average particle sizes of the metal oxide particles are from 2 to 500 nm.

9. Metal oxide nanoparticles according to claim 2 wherein the phosphonates of formula (I) are present in an amount of 5-500 μmol per gram solid coated particle.

10. Phosphonate of formula (I) 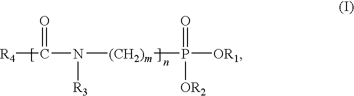
wherein
R₁ and R₂ are independently from each other hydrogen or linear C₁-C₆alkyl or branched C₃-C₆alkyl,
R₃ is hydrogen or C₁-C₄alkyl,
R₄ is linear or branched C₁-C₃₂alkyl, which can be substituted by one or more substituent chosen from the group consisting of halogen, nitrile, azido, COOR₅, NR₆R₇, CONHR₈ and OR₉,
wherein R₅, R₆, R₇, R₈ and R₉ are independently from each other hydrogen, linear or branched C₁-C₃₂alkyl, linear or branched C₂-C₃₂alkenyl, phenyl or C₁-C₄alkylene-phenyl,
linear or branched C₂-C₃₂alkenyl, which can be substituted by one or more substituent chosen from the group consisting of halogen, nitrile, azido, COOR₅, NR₆R₇, CONHR₈ and OR₉,
wherein R₅, R₆, R₇, R₈ and R₉ have the same meanings as defined above, or R₄ is a moiety of formula (a) 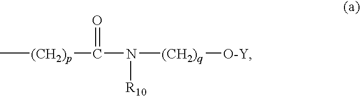
wherein
R₁₀ is hydrogen or C₁-C₄alkyl,
Y is an α- or β-hexo-furanoside or pyranoside or a disaccharide,
p is an integer from 1 to 8,
q is an integer from 1 to 16,
n is 0 or 1 and
m is an integer from 1 to 8.

11. Phosphonate according to claim 10,
wherein
R₁ and R₂ are independently from each other hydrogen or linear C₁-C₄alkyl or branched C₃-C₆alkyl,
R₃ is hydrogen or CH₃,
R₄ is linear or branched C₁-C₂₆alkyl, which can be substituted by one or more substituent chosen from the group consisting of halogen, nitrile, azido, COOR₅, NR₆R₇, CONHR₈ and OR₉,
wherein R₅, R₆, R₇, R₈ and R₉ are independently from each other hydrogen, linear or branched C₁-C₂₀ alkyl, linear or branched C₂-C₂₀alkenyl, phenyl or C₁-C₄alkylene-phenyl,
linear or branched C₂-C₂₆ alkenyl, which can be substituted by one or more substituent chosen from the group consisting of halogen, nitrile, azido, COOR₅, NR₆R₇, CONHR₈ and OR₉,
wherein R₅, R₆, R₇, R₈ and R₉ have the same meanings as defined above, or R₄ is a moiety of formula (a) 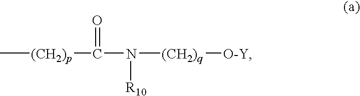
wherein
R₁₀ is hydrogen or C₁-C₂alkyl,
Y is selected from ribose, arabinose, xylose, lyxose, glucose, galactose, mannose, maltose, lactose, 2-N-acetyllactose, cellobiose and derivatives thereof,
p is an integer from 1 to 4,
q is an integer from 2 to 6,
n is 0 or 1 and
m is an integer from 2 to 4.

12. Phosphonate according to claim 11,
wherein
R₁ and R₂ are independently from each other hydrogen or linear C₁-C₂alkyl or branched C₃-C₆alkyl,
R₃ is hydrogen,
R₄ is linear or branched C₁-C₂₂alkyl, which can be substituted by one or more substituent chosen from the group consisting of Cl, F, Br, nitrile, azido, COOR₅, NR₆R₇, CONHR₈ and OR₉,
wherein R₅, R₆, R₇, R₈ and R₉ are independently from each other hydrogen, linear or branched C₁-C₁₀alkyl, linear or branched C₂-C₁₀alkenyl, phenyl or C₁-C₂alkylene-phenyl,
linear or branched C₂-C₂₂ alkenyl, which can be substituted by one or more substituent chosen from the group consisting of halogen, nitrile, azido, COOR₅, NR₆R₇, CONHR₈ and OR₉,
wherein R₅, R₆, R₇, R₈ and R₉ have the same meanings as defined above, or R₄ is a moiety of formula (a).

13-14. (canceled)

15. Process of production of the metal oxide nanoparticles coated with phosphonates of formula (I) according to claim 1, wherein the metal oxides are mixed with the phosphonates of formula (I) in an organic solvent at elevated temperature.

16-20. (canceled)

21. A process of production of the phosphonates of formula (Ia) 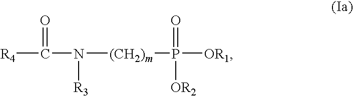
comprising the following steps:
step 1) adding a phosphite of formula (b) to a compound of formula (a) at a temperature of from 40° C. to 180° C. to obtain a reaction product of formula (c) 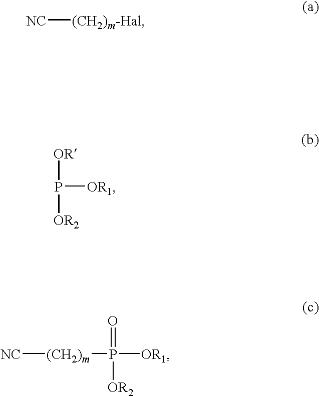
step 2) subsequently reducing the reaction product of formula (c) in a protic solvent containing a C₁₋₄ alcohol and 5-15 weight % of ammonia as cosolvent under 50-150 bar of hydrogen pressure in the presence of a metal catalyst to obtain an amine of formula (d) 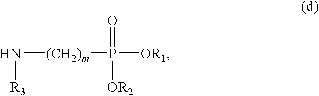
step 3) reacting the amine of formula (d), with a carbonic acid or acid chloride of formula (e) wherein Y′ is Cl or OH in the presence of an organic or inorganic base optionally in the presence of an additional coupling auxiliary 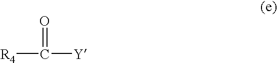
wherein
R₁ and R₂ are independently from each other hydrogen or linear C₁-C₆alkyl or branched C₃-C₆alkyl,
R′ is the same as R1 or R2,
R₃ is hydrogen or C₁-C₄alkyl,
R₄ is linear or branched C₁-C₃₂alkyl, which can be substituted by one or more substituent chosen from the group consisting of halogen, nitrile, azido, COOR₅, NR₆R₇, CONHR₈ and OR₉,
wherein R₅, R₆, R₇, R₈ and R₉ are independently from each other hydrogen, linear or branched C₁-C₃₂alkyl, linear or branched C₂-C₃₂alkenyl, phenyl or C₁-C₄alkylene-phenyl,
linear or branched C₂-C₃₂alkenyl, which can be substituted by one or more substituent chosen from the group consisting of halogen, nitrile, azido, COOR₅, NR₆R₇, CONHR₈ and OR₉,
wherein R₅, R₆, R₇, R₈ and R₉ have the same meanings as defined above, or R₄ is a moiety of formula (a) 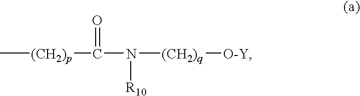
wherein
R₁₀ is hydrogen or C₁-C₄alkyl,
Y is an α- or β-hexo-furanoside or pyranoside or a disaccharide,
p is an integer from 1 to 8,
q is an integer from 1 to 16,
and m is an integer from 1 to 8.

22. A process for the production of phosphonates of formula (Ib) 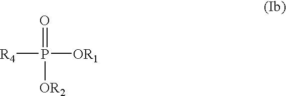
wherein a halide of formula (a′) is heated together with a phosphite of formula (b) in a solvent 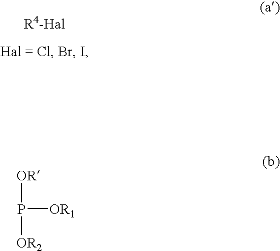
wherein
R₁ and R₂ are independently from each other hydrogen or linear C₁-C₆alkyl or branched C₃-C₆alkyl,
R′ is the same as R1 or R2,
R₃ is hydrogen or C₁-C₄alkyl,
R₄ is linear or branched C₁-C₃₂alkyl, which can be substituted by one or more substituent chosen from the group consisting of halogen, nitrile, azido, COOR₅, NR₆R₇, CONHR₈ and OR₉,
wherein R₅, R₆, R₇, R₈ and R₉ are independently from each other hydrogen, linear or branched C₁-C₃₂alkyl, linear or branched C₂-C₃₂alkenyl, phenyl or C₁-C₄alkylene-phenyl,
linear or branched C₂-C₃₂alkenyl, which can be substituted by one or more substituent chosen from the group consisting of halogen, nitrile, azido, COOR₅, NR₆R₇, CONHR₈ and OR₉,
wherein R₅, R₆, R₇, R₈ and R₉ have the same meanings as defined above, or R₄ is a moiety of formula (a) 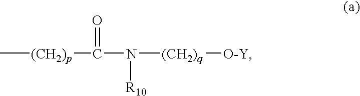
wherein
R₁₀ is hydrogen or C₁-C₄alkyl,
Y is an α- or β-hexo-furanoside or pyranoside or a disaccharide,
p is an integer from 1 to 8,
q is an integer from 1 to 16,
and m is an integer from 1 to 8.

23. A polymer substrate or personal care preparation which has incorporated therein an antimicrobially effective amount of at least one metal oxide nanoparticle according to claim 1.

24. A flame retardant polymer material which contains from 1 to 30% by weight, based on the polymer material of at least one metal oxide nanoparticle according to claim 1.

25. A flame retardant polymer material which contains from 1 to 30% by weight, based on the polymer material of at least one phosphonate according to claim 10.

26. A method for providing long-term hygienic activity on a surface of a material, which process comprises coating onto the surface and/or incorporating into the material a composition comprising an antimicrobially effective amount of at least one metal oxide nanoparticle according to claim 1.
